(19) United States
(12) Patent Application Publication
(10) Pub. No.: US 2018/0185814 A1
(43) Pub. Date: Jul. 5, 2018

(54) NANOSTRUCTURED COMPOSITES FOR GAS SEPARATION AND STORAGE

(71) Applicant: The Regents of the University of California, Oakland, CA (US)

(72) Inventors: Jeffrey J. Urban, Emeryville, CA (US); Eun Seon Cho, Emeryville, CA (US); Felix Raoul Fischer, Berkeley, CA (US); Anne M. Ruminski, El Cerrito, CA (US); Shaul Aloni, Albany, CA (US); Yi-Sheng Liu, Fremont, CA (US); Jinghua Guo, Orinda, CA (US); Ryan Cloke, Oakland, CA (US); Tomas Marangoni, Berkeley, CA (US); Cameron Rogers, Berkeley, CA (US)

(21) Appl. No.: 15/570,501

(22) PCT Filed: May 6, 2016
(86) PCT No.: PCT/US16/31360

§ 371 Date: Oct. 30, 2017

Related U.S. Application Data
(60) Provisional application No. 62/157,952, filed on May 6, 2015.
(60) Provisional application No. 62/203,198, filed on Aug. 10, 2015.

(51) Int. Cl. B01J 20/04; B01J 20/20; B01J 20/28; B01J 20/30; C01B 3/00; C01B 13/02; C01B 3/04; B01D 53/22; C25B 1/04

(52) U.S. Cl. CPC B01J 20/04; B01J 20/205; B01J 20/28007; B01J 20/28026; B01J 20/3021; C25B 1/04; C01B 3/0078; C01B 13/0207; C01B 3/042; B01D 53/228; C01B 3/0021

(57) ABSTRACT

The disclosure provides nanostructured composites of graphene derivatives and metal nanocrystals for gas storage and gas separation.

### CROSS REFERENCE TO RELATED APPLICATIONS

This application claims priority under 35 U.S.C. § 119 from Provisional Application Ser. No. 62/157,952, filed May 6, 2015, and Provisional Application Ser. No. 62/203,198, filed Aug. 10, 2015, the disclosures of which are incorporated herein by reference.

### STATEMENT OF GOVERNMENT SUPPORT

The invention was funded in part by Grant No. DE-SC0010409 awarded by the United States Department of Energy, and by Grant No. DE-ACO2-05CH11231 awarded by the Department of Energy. The government has certain rights in the invention.

### TECHNICAL FIELD

The disclosure provides nanostructured composites of graphene derivatives and metal nanocrystals for gas storage and gas separation.

### BACKGROUND

Major car manufacturers have made commitments to hydrogen as a “fuel of the future”. Currently, hydrogen storage for FCEVs (fuel cell electric vehicles) utilizes compressed gas tanks. These tanks, however, severely compromise on-board occupancy and cannot meet long-term storage requirements. Solid-state hydrogen storage in metal hydrides is one of the few materials capable of providing sufficient storage density required to meet these long-term targets, however, simultaneously meeting gravimetric, volumetric, thermodynamic, and kinetic requirements has proven challenging due to the strong binding enthalpies for the metal hydride bonds, long diffusion path lengths, and oxidative instability of zero-valent metals.

### SUMMARY

The disclosure provides a nanostructured composite comprising sheets or layers of graphene derivatives or graphene nanoribbons and a plurality of metal nanocrystals located between and in contact with the sheets or layers of the graphene derivatives, wherein the nanostructured composite is capable of reversibly adsorbing one or more gases. In one embodiment, the metal nanocrystals comprise a metal which remains at a zero valence state after exposure to oxygen and/or moisture. In another or further embodiment, the plurality of metal nanocrystals comprise a metal selected from beryllium, magnesium, aluminum, calcium, scandium, titanium, vanadium, chromium, manganese, iron, cobalt, nickel, copper, zinc, and tin. In yet a further embodiment, the plurality of metal nanocrystals comprise magnesium. In another embodiment, the plurality of metal nanocrystals have a diameter from 1 nm to 20 nm. In a further embodiment, the plurality of metal nanocrystals have a diameter from about 2 nm to 4.5 nm. In yet another embodiment, the graphene derivatives are selected from one or more of the following structures:

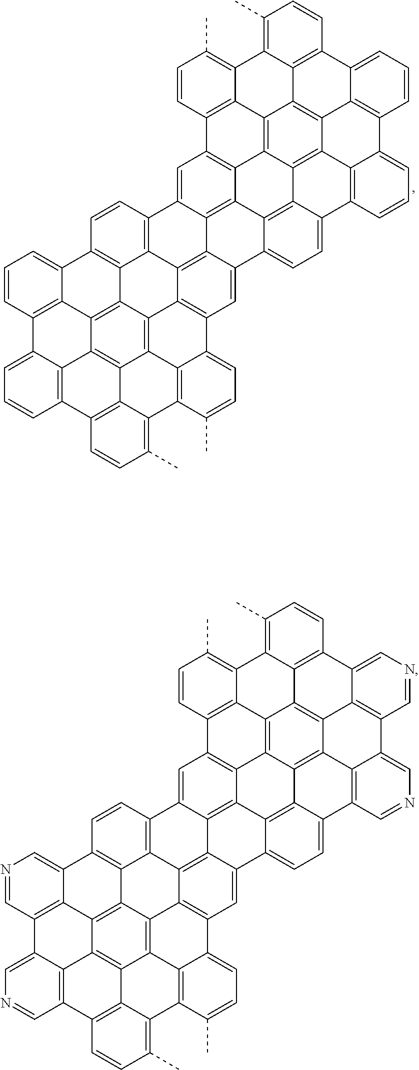

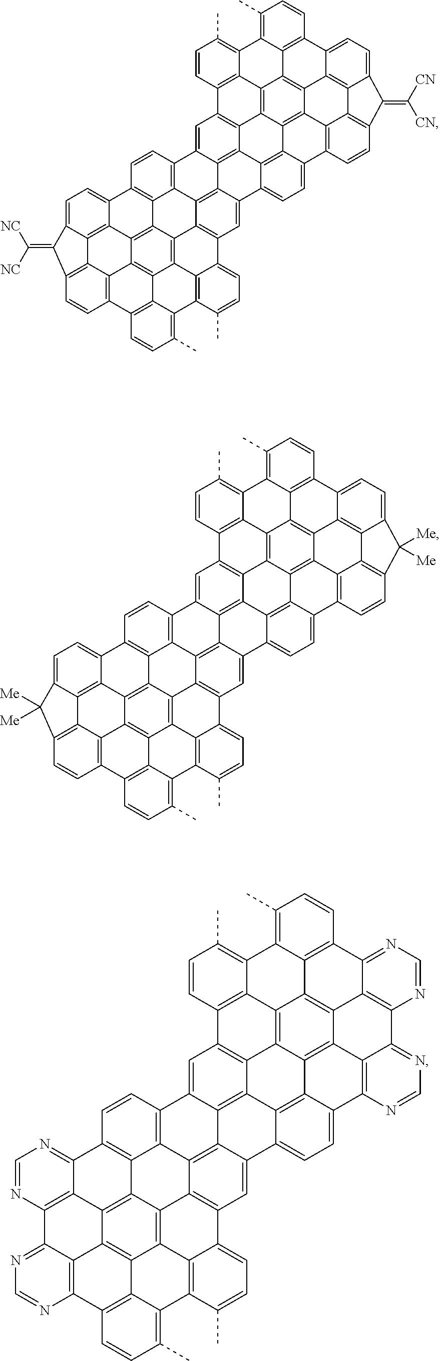

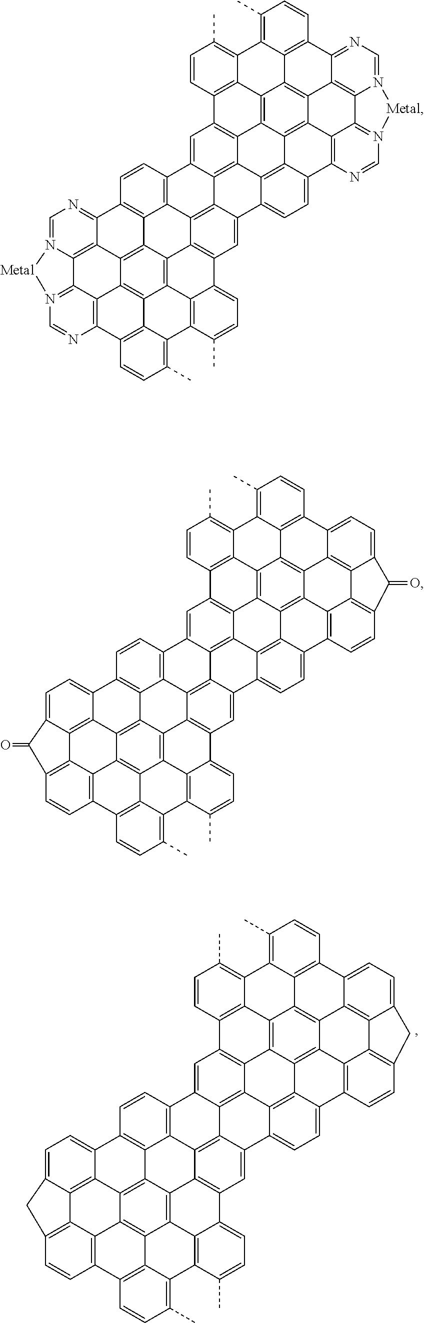

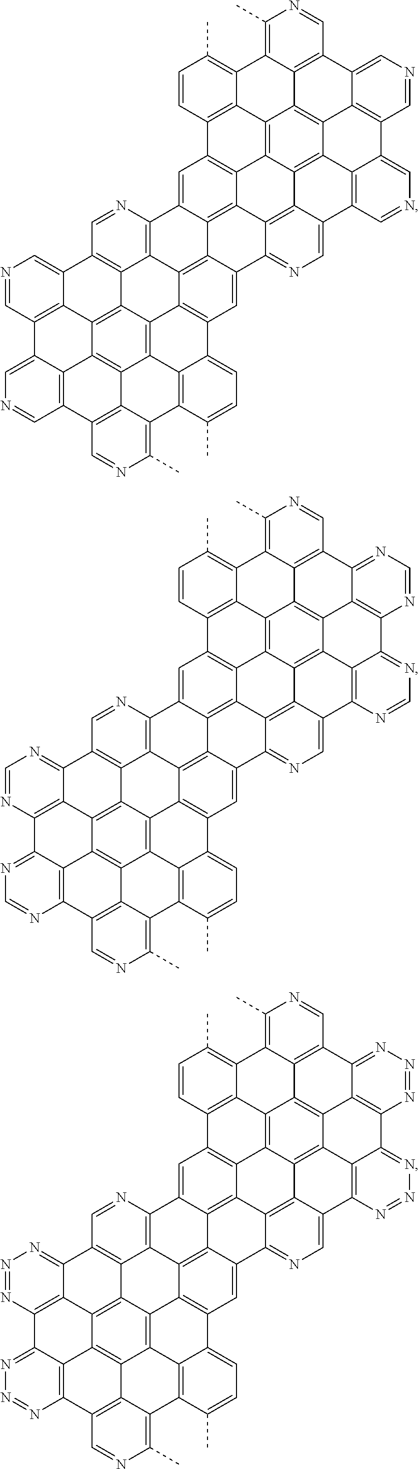

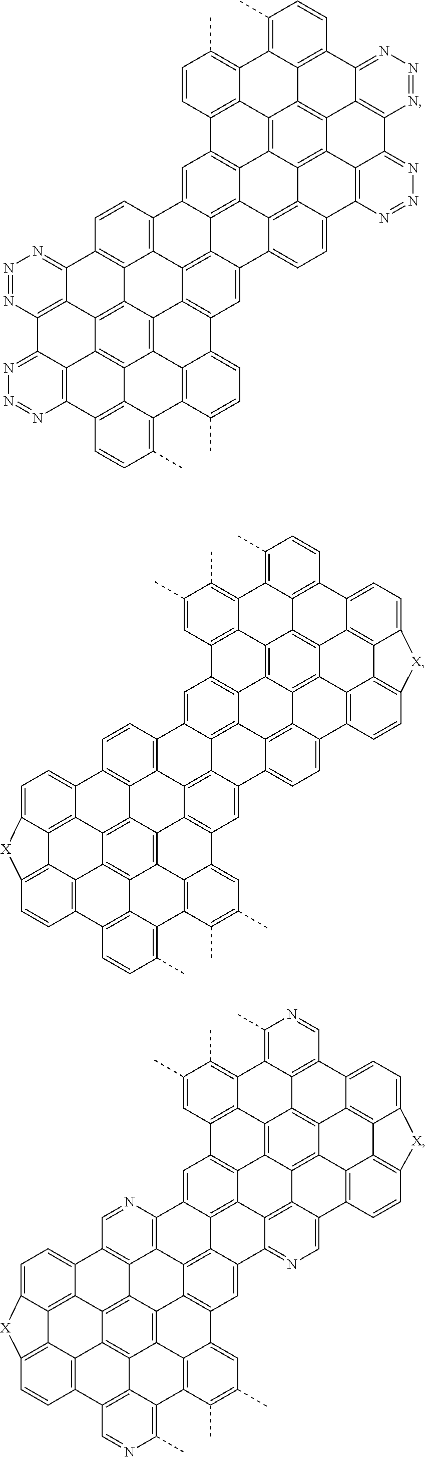

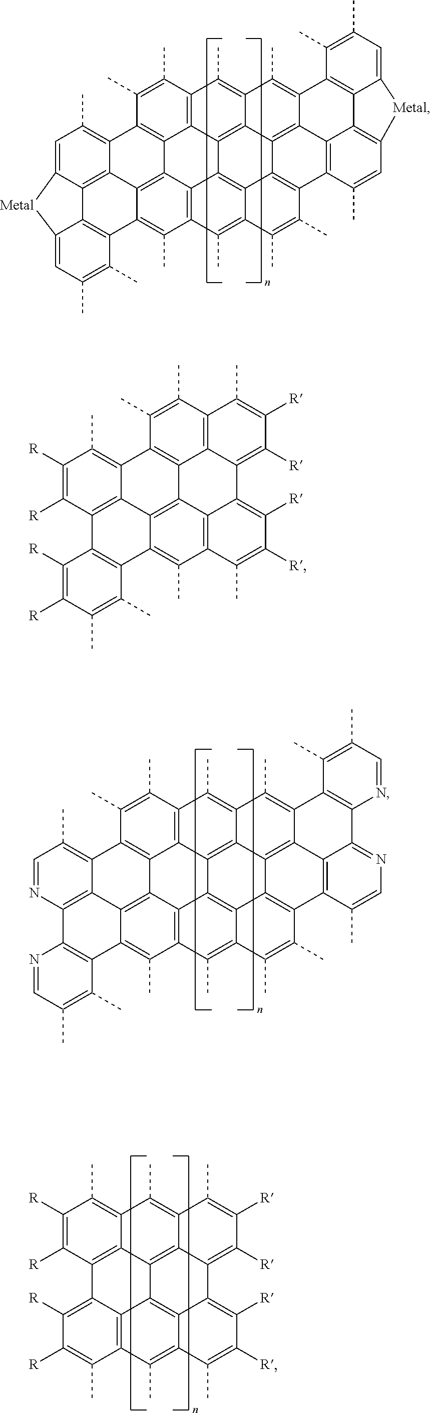

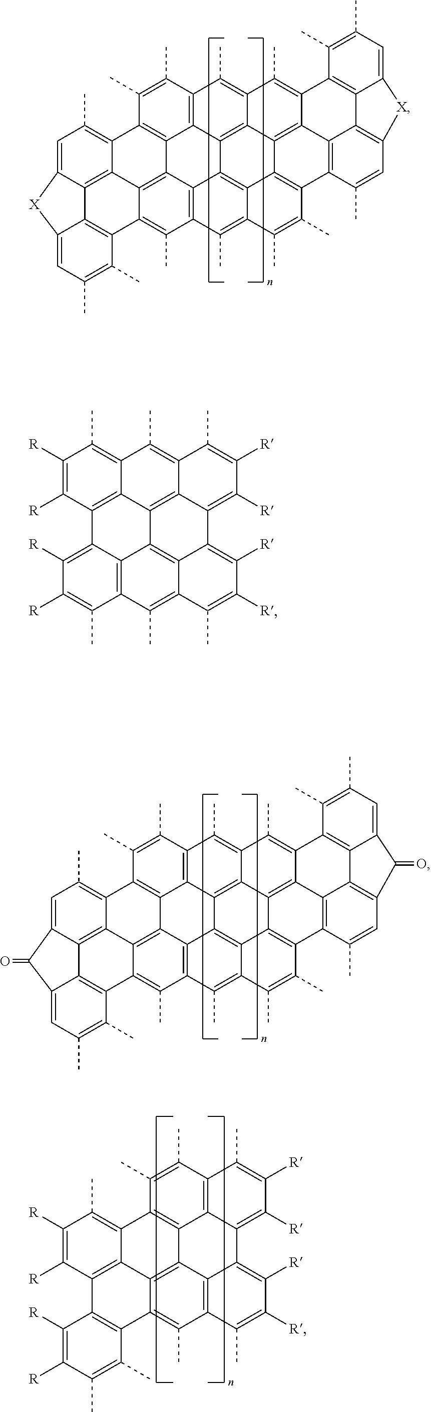

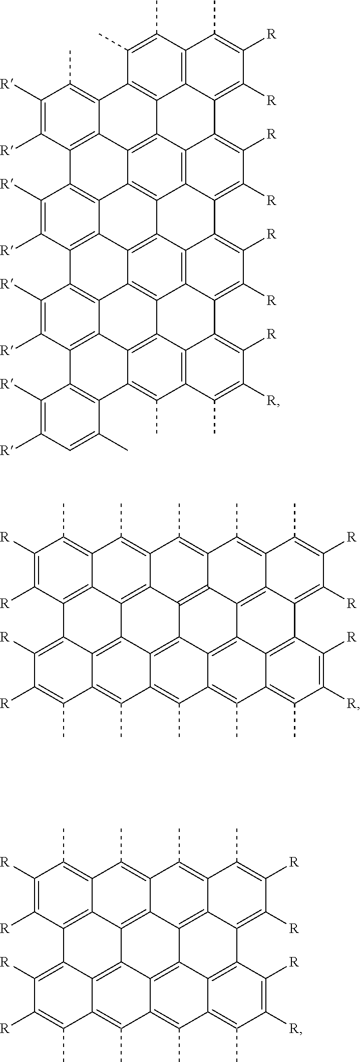

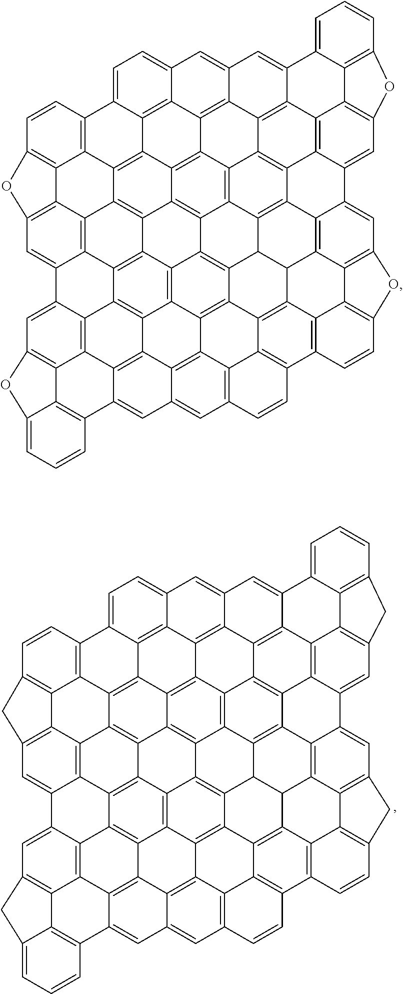

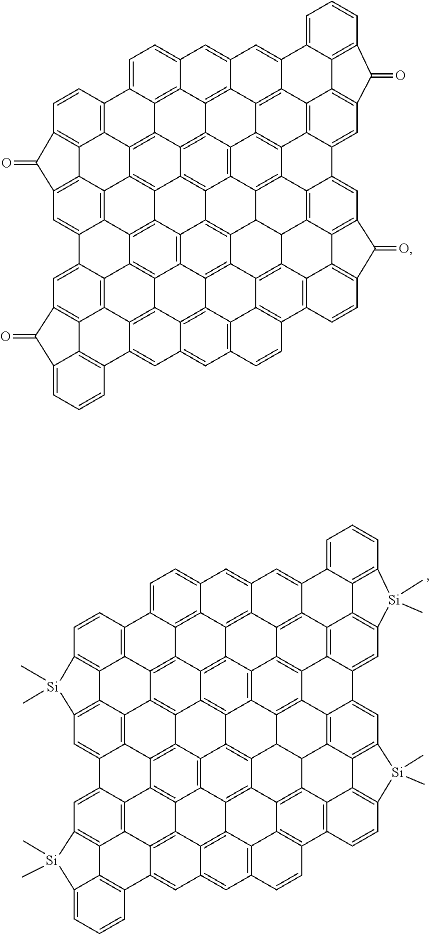

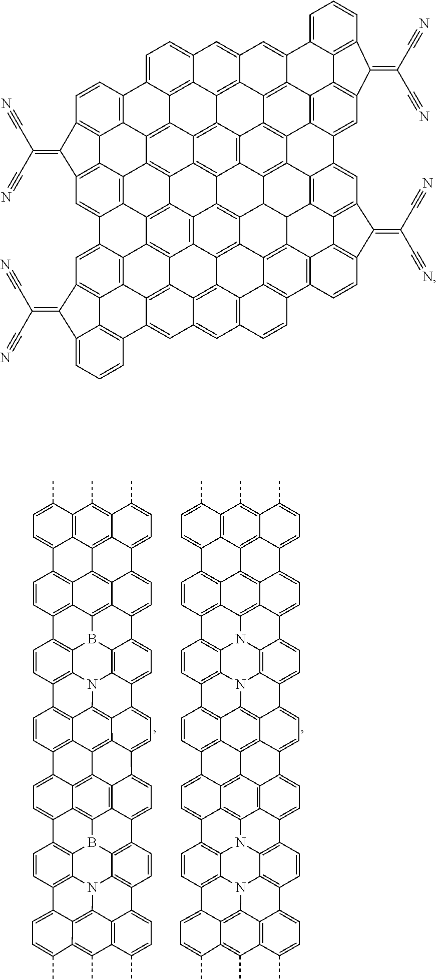

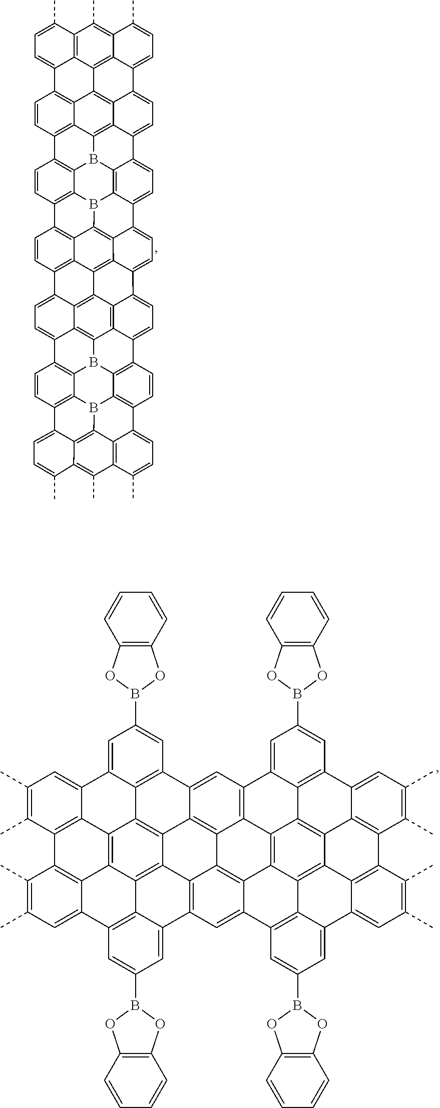

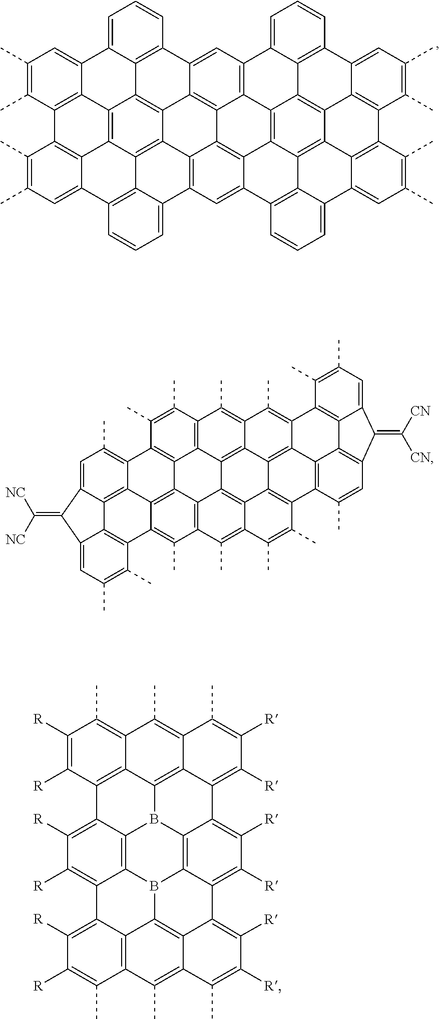

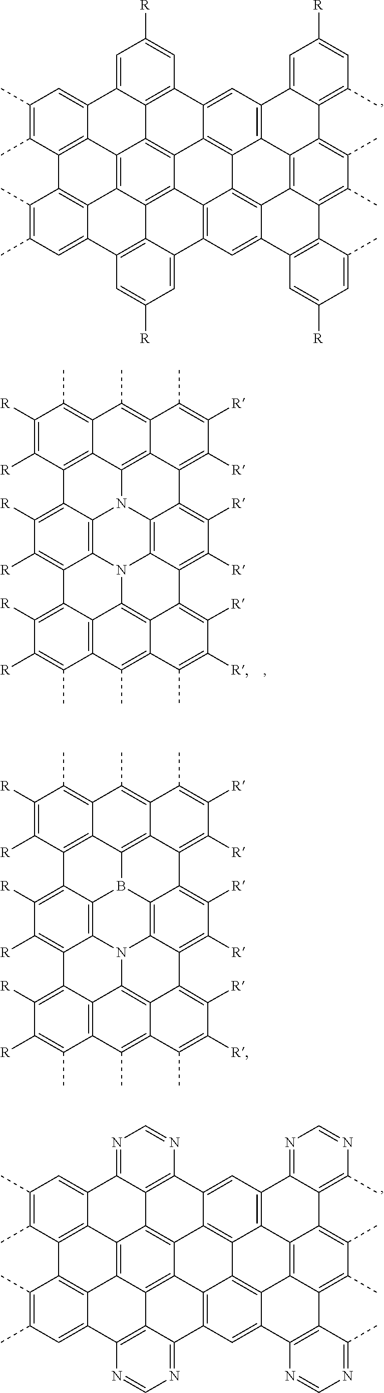

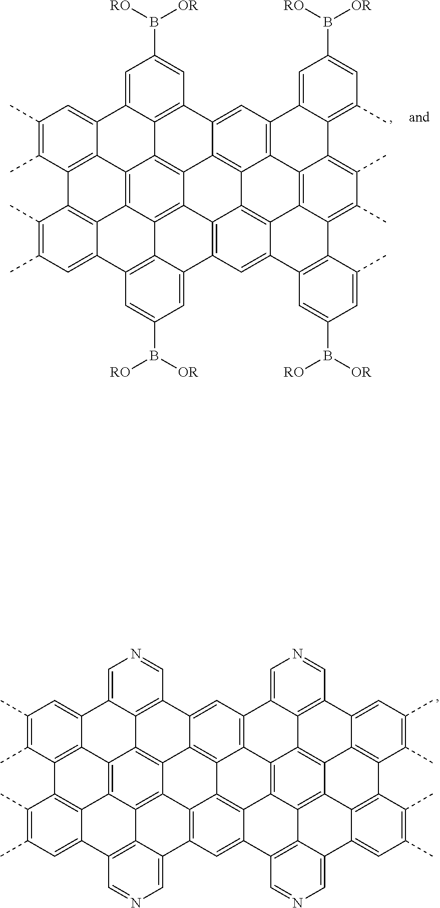

wherein n can be 1 to 1000 (or any number there between), R and R′ are independently selected from H, D, optionally substituted alkyl, optionally substituted heteroalkyl, optionally substituted alkenyl, optionally substituted heteroalkenyl, optionally substituted alkynyl, optionally substituted heteroalkynyl, optionally substituted cycloalkyl, optionally substituted cycloalkenyl, optionally substituted aryl, optionally substituted heterocycle, hydroxyl, halo, imine, amine (e.g., NH₂ and NR¹₂), amide, nitro, nitroso, nitrile, isocyanate, alkoxide (e.g., O-alkyl and O-ether), ester, aldehyde, ketone, carboxyl, thiol, SH, SRI-, thionyl, sulfonyl, SiR¹₃, PRI-₃, and heterocycle; R¹ is selected from an optionally substituted alkyl, an optionally substituted heteroalkyl, an optionally substituted alkenyl, an optionally substituted heteroalkenyl, an optionally substituted alkynyl, or an optionally substituted heteroalkynyl, a cycloalkyl, an aryl, and a heterocycle; and X is selected from O, S, N—R, P—R², and B—R² where R² is an optionally substituted alkyl, an optionally substituted heteroalkyl, an optionally substituted alkenyl, an optionally substituted heteroalkenyl, an optionally substituted alkynyl, or an optionally substituted heteroalkynyl, a cycloalkyl, an aryl, and a heterocycle. In another embodiment, the structures have been oxidized to form graphene oxide structures. In a further embodiment, the structures have been oxidized and reduced to form reduced graphene oxide structures. In yet another embodiment, the graphene derivatives are graphene oxide or reduced graphene oxide. In yet another embodiment, the nanostructured composite is capable of reversibly adsorbing hydrogen gas. In still a further embodiment, the hydrogen gas is reversibly adsorbed to the nanostructured composites by interacting with the plurality metal nanocrystals. In another embodiment, the nanostructured composites are able to store and deliver hydrogen gas at a gravimetric capacity which exceeds 5.5 wt % of the nanostructured composite. In a further embodiment, the nanostructured composites are able to store and deliver hydrogen gas at a gravimetric capacity which exceeds 6.0 wt % of the nanostructured composite. In yet a further embodiment, the nanostructured composites are able to store and deliver hydrogen gas at a gravimetric capacity which is about 6.38 wt % of the nanostructured composite. In another embodiment, the nanostructured composites further comprise adsorbed hydrogen gas.

The disclosure also provides a gas storage device comprising the nanostructured composites of the disclosure. In one embodiment, the device is used with a fuel cell and/or an internal combustion engine. In another embodiment, the device is configured to be used in a vehicle.

The disclosure also provides a gas separation device comprising the nanostructured composites of the disclosure. In one embodiment, the gas separation device is a membrane-based separation device.

The disclosure also provides a method to separate and/or store hydrogen gas, comprising contacting a nanostructured composite of the disclosure with hydrogen gas or a gas mixture comprising hydrogen gas. In one embodiment, the method is performed at a temperature from 100° C. to 300° C. In another embodiment, the method is performed at between 5 to 200 bar. In still another embodiment, the method is performed at about 15 bar. In another embodiment, the adsorbed hydrogen gas can be released from the nanostructured composite by heating the nanostructured composite at a temperature from 25° C. to 350° C. and/or reducing the pressure to 0 bar. In yet another embodiment, the gas mixture comprising hydrogen gas is selected from water gas, partial decomposition of gaseous hydrocarbons, natural gas, and waste gas from destructive hydrogenation processes.

The disclosure also provides a method to fabricate the nanostructured composites of the disclosure, comprising adding a mixture comprising ball-milled graphene oxide, bis(cyclopentadienyl)magnesium, and a first solvent to a solution comprising a reducing agent and a second solvent, wherein the first and second solvent may or may not be the same solvent. In one embodiment, the reducing agent is selected from lithium naphthalenide, hydrazine, thiourea dioxide, NaHSO₃, sodium borohydride, and thiophene. In another embodiment, the reducing agent is lithium naphthalenide. In yet another embodiment of any of the foregoing, the first and second solvent is tetrahydrofuran.

The disclosure also provides a catalytic, CO₂ reduction or water splitting method comprising the nanostructured composite of the disclosure. In one embodiment, the composite materials comprises a graphene nanoribbon or derivative and Au nanoparticles for electrocatalytic CO₂ reduction.

### DESCRIPTION OF DRAWINGS

FIG. 1A-F provides (A) a schematic representation of the nanostructured composite material comprising reduced graphene oxide and magnesium nanocrystals (rGO-Mg); (B) representative transmission electron microscopy (TEM) images of the nanostructured rGO-Mg composites showing the high density of Mg nanocrystals with no visible aggregates. The upper inset is a high-resolution image and the lower inset is diffraction pattern where the hexagonal dots are matched to Mg (100), corresponding to 2.778 Å of d-spacing (JCPDS 04-0770); (C) representative x-ray diffraction (XRD) spectra demonstrating the stability of the nanostructured rGO-Mg composites after 3 months in air. The bottom bars represent a XRD pattern of Mg, MgH₂, Mg(OH)₂, MgO; and (D) EELS spectrum of a representative rGO-Mg composite flake suspended over a hole in the support. The spectra shows a dominant Mg L-edge peak and a carbon K-edge peak associated with large quantity of Mg crystals and rGO support. (E) Hydrogen absorption/desorption (at 200° C. and 15 bar H₂/300° C. and 0 bar) for the prepared rGO-Mg multilaminates. (F) Hydrogen absorption/desorption cycling of rGO-Mg multilaminates that were first exposed to air overnight. The first 5 cycles were performed at 250° C. and 15 bar H₂/350° C. and 0 bar, and the additional 20 cycles at 200° C. and 15 bar H²/300° C. and 0 bar.

FIG. 2A-B provides TEM images of the nanostructured rGO-Mg composites at various fields of magnification. (A) TEM images of the nanostructured rGO-Mg composites after synthesis. The diffraction patterns were analyzed via Image J Radial Profile Angle software, which produces a plot of normalized integrated radial intensities; the corresponding plot is shown here in the lower right hand panel; and (B) TEM images of the nanostructured rGO-Mg composites after hydrogen cycling. The diffraction patterns were analyzed via Image J Radial Profile Angle software, which produces a plot of normalized integrated radial intensities; the corresponding plot is shown here in the lower right hand panel.

FIG. 3 provides an XRD spectra of the composite after cycling (5 cycles) with partial desorption and subsequent air exposure. The bottom bars represent a XRD pattern of Mg (red), MgH₂ (pink), Mg(OH)₂ (green), MgO (blue).

FIG. 4A-B presents characterization of the nanostructured rGO-Mg composites for hydrogen absorption/desorption. (A) Hydrogen absorption/desorption (at 200° C. and 15 bar H₂/300° C. and 0 bar) for the prepared nanostructured rGO-Mg composites. Inset: Hydrogen absorption/desorption cycling at 250° C. and 15 bar H₂/350° C. and 0 bar; and (B) XRD spectra of nanostructured rGO-Mg composites after absorption/desorption (The bottom bars represent the XRD patterns of Mg (red), MgH₂ (pink), Mg(OH)₂ (green), MgO (blue).

FIG. 5 presents curves for the hydrogen absorption of graphene oxide. Line represent hydrogen absorption at 200° C. and 250° C., for 4 hours at 15 bar H₂. (The inset shows a magnified version for the first hour of absorption.)

FIG. 6A-B presents characterization of the nanostructured rGO-Mg composites for hydrogen absorption/desorption at various temperatures. (A) Hydrogen absorption at three different temperatures (right: 200° C., middle: 225° C., left: 250° C.) at 15 bar H₂; (B) Hydrogen desorption at three different temperatures (right: 300° C., middle: 325° C., left: 350° C.) at 0 bar. The inset shows two different desorption regions at 300° C.

FIG. 7A-B presents the kinetics or hydrogen absorption/desorption by the nanostructured rGO-Mg composites. (A) Hydrogen absorption at 250° C. at 15 bar H₂; and (B) Hydrogen desorption at 300° C. at 0 bar for rGO-Mg (top) and Mg-PMMA (bottom).

FIG. 8A-B presents the kinetics or hydrogen absorption/desorption by the nanostructured rGO-Mg composites. (A) Hydrogen absorption at 200° C. and 15 bar H₂ with different amount of GO, as indicated (the original amount of GO discussed is 6.25 mg, as described below). (B) The first 0.5 hour of the H₂ absorption traces are magnified, better demonstrating the clear difference in kinetics.

FIG. 9A-C presents X-ray Absorption Near Edge Structure (XANES) and Raman spectral analysis of graphene oxide (GO) and the nanostructured rGO-Mg composites before and after hydrogen cycling. (A) XANES spectra of GO and the nanostructured rGO-Mg composites after synthesis and after cycling at carbon K-edge; (B) Raman spectra of GO and the nanostructured rGO-Mg composites after synthesis and after H₂ cycling; and (C) the 2D peak region.

FIG. 10A-D presents XPS spectra of the nanostructured composites after synthesis and after hydrogen cycling. XPS spectra (C 1s) of (A) GO; (B) nanostructured composites after synthesis; (C) nanostructured composites after H₂ cycling; and (D) XPS pattern (Mg 2s) for the nanostructured composites after synthesis and after H₂ cycling.

FIG. 11 shows illustrates a histogram of Mg nanocrystal size distribution (3.26 nm diameter (±0.87 nm)) as determined by TEM.

FIG. 12A-B provides (A) chemical structures of graphene nanoribbons (GNRs) specifically used here, abbreviated by C-GNR, 2N_GNR, 4N_GNR and ke_GNR; (B) representative x-ray diffraction (XRD) spectra demonstrating the stability of the nanostructured GNR-Mg composites after 3 months in air.

FIG. 13 provides an XRD spectra of the GNR-Mg composite after synthesis, hydrogen absorption, and hydrogen cycling and subsequent air exposure. The bottom bars represent a XRD pattern of Mg, MgH₂, Mg(OH)₂, MgO.

FIG. 14A-F presents hydrogen absorption/desorption characterization of the GNR-Mg composites at three different temperatures. Hydrogen absorption at 15 bar H₂ and (A) 200° C., (B) 225° C., (C) 250° C.; and hydrogen desorption at 0 bar H₂ and (D) 300° C., (E) 325° C., (F) 350° C.

FIG. 15 presents curves for the hydrogen absorption of pure graphene nanoribbon. Black and red lines represent hydrogen absorption at 200° C. and 250° C., respectively, for 4 hours at 15 bar H₂. (The inset shows a magnified version.)

FIG. 16 presents Raman spectra of GNR and the nanostructured GNR-Mg composites after synthesis and after H₂ cycling.

### DETAILED DESCRIPTION

As used herein and in the appended claims, the singular forms “a,” “and,” and “the” include plural referents unless the context clearly dictates otherwise. Thus, for example, reference to “a nanostructured composite” includes a plurality of such nanostructure composites and reference to “the metal nanocrystal” includes reference to one or more metal nanocrystals and equivalents thereof known to those skilled in the art, and so forth.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Unless defined otherwise, all technical and scientific terms used herein have the same meaning as commonly understood to one of ordinary skill in the art to which this disclosure belongs. Although many methods and reagents similar or equivalent to those described herein can be used in the practice of the disclosed methods and compositions, the exemplary methods and materials are now described.

All publications mentioned herein are incorporated herein by reference in their entirety for the purposes of describing and disclosing methodologies that might be used in connection with the description herein. Moreover, with respect to any term that is presented in one or more publications that is similar to, or identical with, a term that has been expressly defined in this disclosure, the definition of the term as expressly provided in this disclosure will control in all respects.

For purposes of this disclosure, “nano” when used as a prefix, such as “nanostructured materials”, refers to structures that are in the nanometer scale (i.e., from 1×10⁻⁹ m up to 1×10⁻⁶ m).

The term “graphene derivatives” as used herein, refers to graphene that has been modified by: (1) functionalization by the addition of one or more heteroatoms, (2) replacement of one or more carbon atoms with one or more heteroatoms, (3) replacement of phenyl groups with other hydrocarbons, (3) oxidation to form graphene oxide, (4) oxidation to form graphene oxide that is subsequently reduced to form reduced graphene oxide, or any combination of the foregoing. In a particular embodiment, graphene derivative refers to reduced graphene oxide that may or may not comprise one or more heteroatoms.

The term “graphene nanoribbons” or “GNRs” as used herein, refers to one-dimensional structures with hexagonal two dimensional carbon lattices that are in the form of ribbons or strips. Typically a graphene nanoribbon has a width dimension of <50 nm and a length dimension of at least 250 nm. Typically the graphene nanoribbon has a ratio of length to width of at least 5:1 to about 1000:2. For purposes of this disclosure, the “graphene nanoribbons” disclosed herein are atomically defined and can have various edge structures and/or comprise heteroatoms that can influence various properties of the nanoribbons, such as gas sorption properties, thermal transport, electronic structure and catalysis. For example, edge effects of the GNRs can provide strong Columbic interactions and can promote selective adsorption by dipole or quadrupole molecules (e.g., H₂O or CO₂). By contrast, dispersion interaction-dominated molecules (Ar, CH₄, and N₂) can be selectively adsorbed on the basal planes of the GNRs. Further, GNRs that are edge functionalized with the polar groups, including —COOH, —NH₂, —NO₂ and —H₂PO₃, can enhance CO₂ and CH₄ adsorption due to strong binding of activating exposed edges and terraces. Accordingly, the gas absorption/desorption kinetics of the nanostructured composites of the disclosure can be fined tuned in part, based upon atomically defining the GNR. The “graphene nanoribbons” of the disclosure are further characterized as being atomically thin thereby allowing for high density gas sorption. In direct contrast to other graphene derivative materials, such as amorphous graphene, graphene oxide (GO) and reduced graphene oxide (rGO), GNRs allow for fine tuning of the nanostructured composites' absorption/desorption gas sorption kinetics, have much smaller volumes, have higher gas storage densities, and have greater hydrogen gas storage capacities (e.g., storage capacity up to at least 7.2 wt %).

The term “graphene sheet” refers to one-dimensional structures with hexagonal two dimensional carbon lattices that are in the form of sheets. Typically a graphene nanoribbon has a width dimension of >50 nm and a length dimension of at least 250 nm. Typically the graphene nanoribbon has a ratio of length to width of at least less than 5:1.

The term “metal nanocrystal” as used herein, refers to nanometer sized materials comprising metal or metalloid atoms that are orientated either in a single- or poly-crystalline arrangement. A “metal nanocrystal” can be formed from any metallic or metalloid element and can have any shape (i.e., spherical, cylindrical, discoidal, tabular, ellipsoidal, equant, irregular, etc.). In certain embodiments presented herein, a metal nanocrystal is comprised of low molecular weight metals, alkaline earth metals, transition metals, and/or metalloids. Examples of metals making up a “metal nanocrystal” include, but are not limited to beryllium, magnesium, aluminum, calcium, scandium, titanium, vanadium, chromium, manganese, iron, cobalt, nickel, copper, zinc, and tin. An inorganic or organic metal salt is typically chosen as the source of metal ions for reduction to form a nanocrystal. In a particular embodiment, the metal nanocrystal has a diameter between 1 nm to 20 nm, 1.5 nm to 10 nm, 1.8 nm to 5 nm or 2 nm to 4.5 nm. In a further embodiment, the metal nanocrystal has a diameter of about 2.39 nm to 4.13 nm.

The established environmental impacts resulting from fossil fuels have stimulated urgent efforts to decarbonize the fuel sources. Hydrogen is the ultimate carbon-free energy carrier—it possesses the highest energy density amongst chemical fuels, and water is the sole combustion product. While commitment to hydrogen fuels is growing for automotive applications, safe, dense, solid-state hydrogen storage remains a formidable scientific challenge. In principle, metal hydrides offer ample reversible storage capacity, and do not require cryogens or exceedingly high pressures for operation. However, despite these advantages, hydrides have been largely abandoned due to oxidative instability and sluggish kinetics. It is reported herein, environmentally stable, and exceptionally dense hydrogen storage (6.38 wt % and 0.103 kg H₂/L in the total composite, 7.42 wt % in Mg) using atomically thin and gas-selective reduced graphene derivative sheets as encapsulants. Other approaches to protecting reactive materials involve energy intensive introduction of considerable amounts of inactive, protective matrix which compromises energy density. However, the nanostructured composites disclosed herein are able to deliver exceptionally dense hydrogen storage far-exceeding 2017 DOE target metrics for gravimetric capacity (5.5 wt %), and ultimate full-fleet volumetric targets (0.070 kg H₂/L) for fuel cell electric vehicles. Additionally, the methods provided herein allow for stabilizing reactive nanocrystalline metals at zero-valency thereby enabling wide-ranging applications for batteries, catalysis, encapsulants, and energetic materials.

Although the benefits of hydrogen based fuels are clear, they remain elusive because of the difficulty in storing enough hydrogen onboard a vehicle to provide a reasonable driving range without compromising passenger or luggage space. In addition to storing kilogram quantities of hydrogen in a small space, it is imperative that hydrogen is stored reversibly so that it can be used and refilled on demand. While major car manufacturers have made commitments to hydrogen as a “fuel of the future”, hydrogen storage for FCEVs (fuel cell electric vehicles) currently relies on compressed gas tanks. These tanks are unable to meet long-term storage targets and severely compromise on-board occupancy. Solid-state hydrogen storage in metal hydrides is one of the few materials capable of providing sufficient storage density required to meet these long-term targets, however, simultaneously meeting gravimetric, volumetric, thermodynamic, and kinetic requirements has proven challenging due to the strong binding enthalpies for the metal hydride bonds, long diffusion path lengths, and oxidative instability of zero-valent metals. While nanostructuring has been shown to optimize binding enthalpies, synthesis and oxidative stabilization of metal nanocrystals is challenging, and protection strategies often involve embedding these crystals in dense matrices which add considerable “dead” mass to the composite, thereby decreasing gravimetric and volumetric density accordingly. Thus, it remains true that no single material has met all of these important criteria, and metal hydrides show the most promise for non-cryogenic applications.

After the first report of the preparation of individual graphene sheets in 2004, its unique optoelectronic properties attracted great attention. Graphene, a two-dimensional carbon allotrope, is an incredibly versatile a material. Graphene is an incredibly light and strong material. Graphene can conduct heat and electricity better than most materials. Accordingly, graphene has found use in a large number of applications. Graphene was first artificially produced by mechanical exfoliating graphite layer by layer until only 1 single layer remained. This resulting monolayer of graphite (known as graphene) is only 1 atom thick and is therefore the thinnest material possible to be created without becoming unstable when being exposed to the elements (temperature, air, etc.). In particular embodiments, the graphene derivatives, such as nanoribbons, of the disclosure have saturated edge states (i.e., the edge carbons are bound by hydrogen atoms, heteroatoms, or other atomically defined functional groups). In a further embodiment, the GNRs of the disclosure are not lithographically patterned GNRs. Accordingly, the GNRs of the disclosure do not suffer from drawbacks seen with GNRs that do not have edge atoms that are not saturated, such as active edge states determining edge structures (i.e., edge reconstructions).

The disclosure provides methods and compositions to obtain environmentally stable, and exceptionally dense hydrogen storage (up to 7.2 wt % of H2 in total composite, reaching nearly the theoretical capacity of a pure magnesium hydride of 7.6 wt %) using atomically thin and gas-selective graphene nanoribbons and/or sheets as encapsulants. Other approaches to protecting reactive materials involve energy intensive introduction of considerable amounts of inactive, protective matrix which compromises energy density. However, the nanostructured composites disclosed herein are able to deliver exceptionally dense hydrogen storage far-exceeding 2017 DOE target metrics for gravimetric capacity (5.5 wt %), and ultimate full-fleet volumetric targets (0.070 kg H2/L) for fuel cell electric vehicles. Additionally, the methods provided herein allow for stabilizing reactive nanocrystalline metals at zero-valency thereby enabling wide-ranging applications for batteries, catalysis, encapsulants, and energetic materials.

The disclosure provides for nanostructured composites comprising mixed dimensional graphene derivatives and metallic nanocrystals. Examples of mixed dimensional graphene derivatives which can be used in the nanostructured composites disclosed herein, include, but are not limited to:

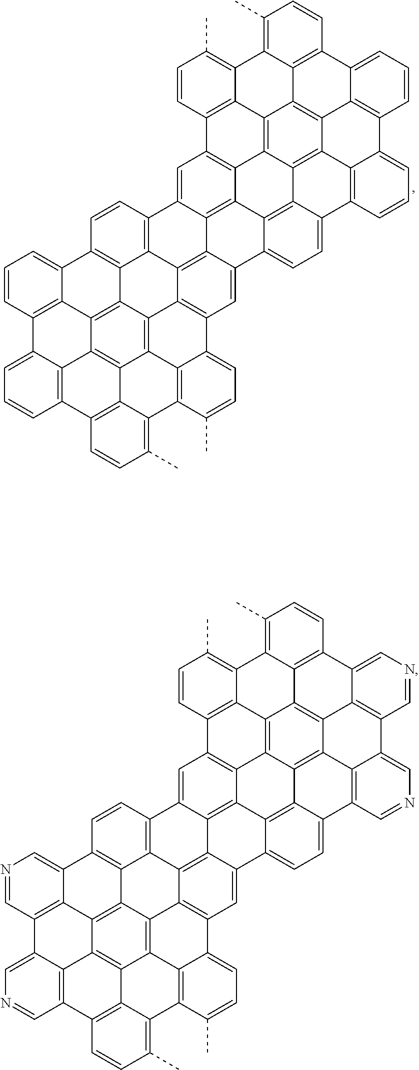

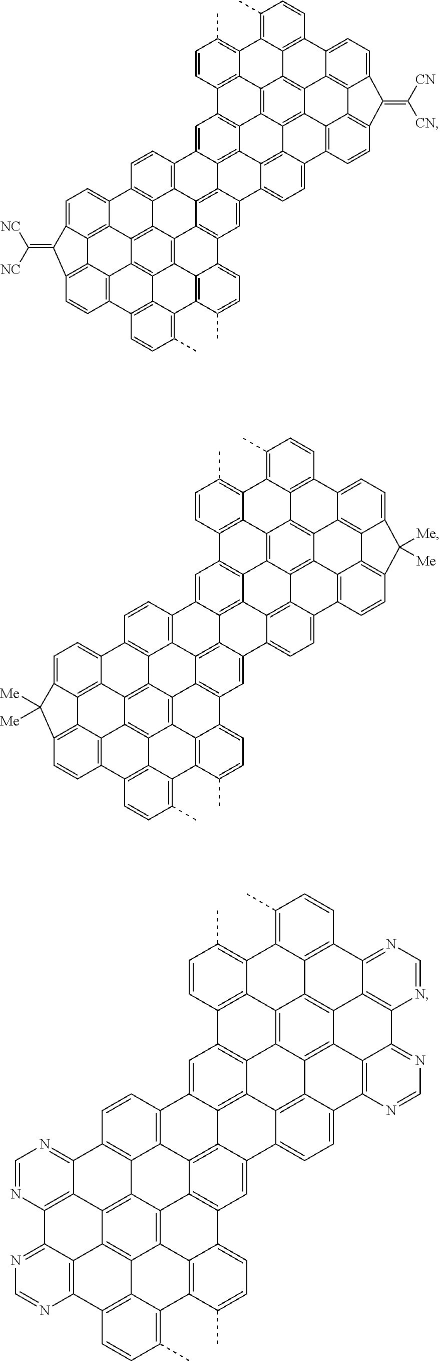

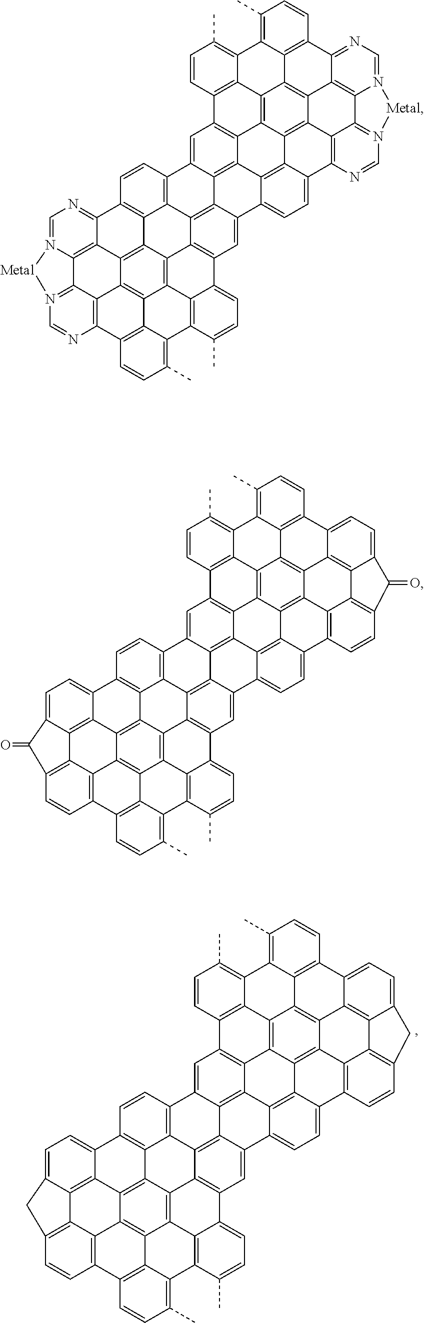

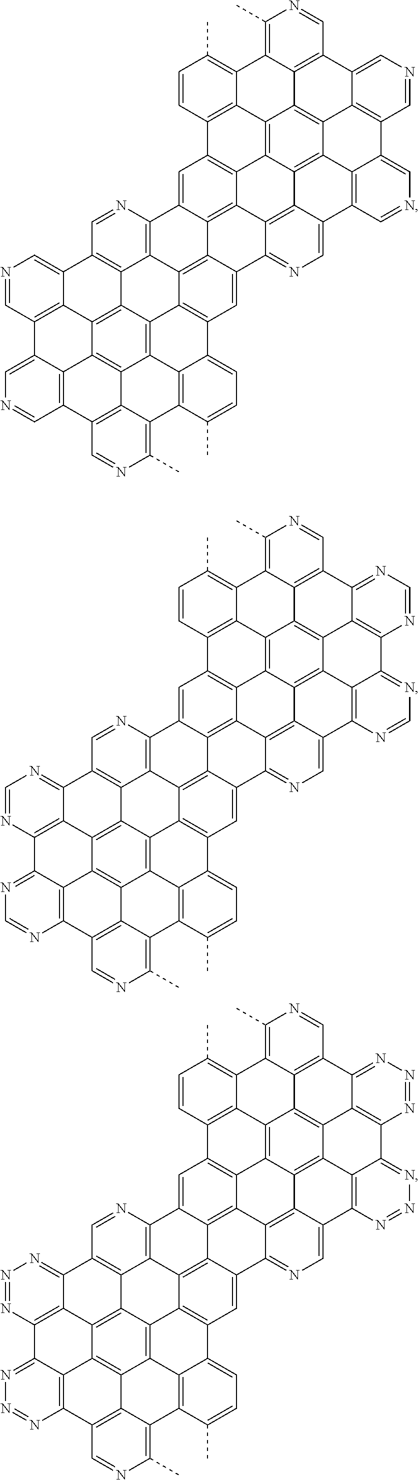

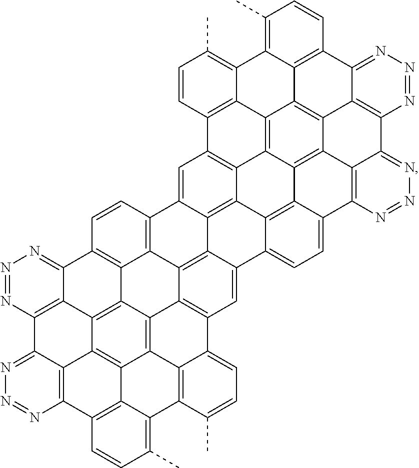

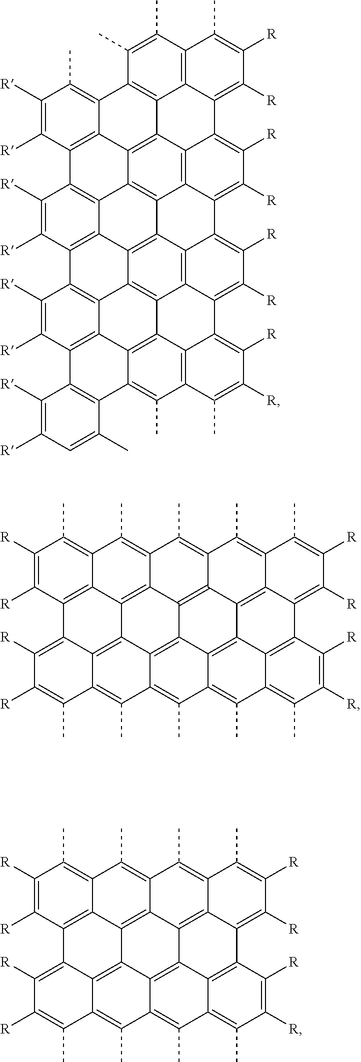

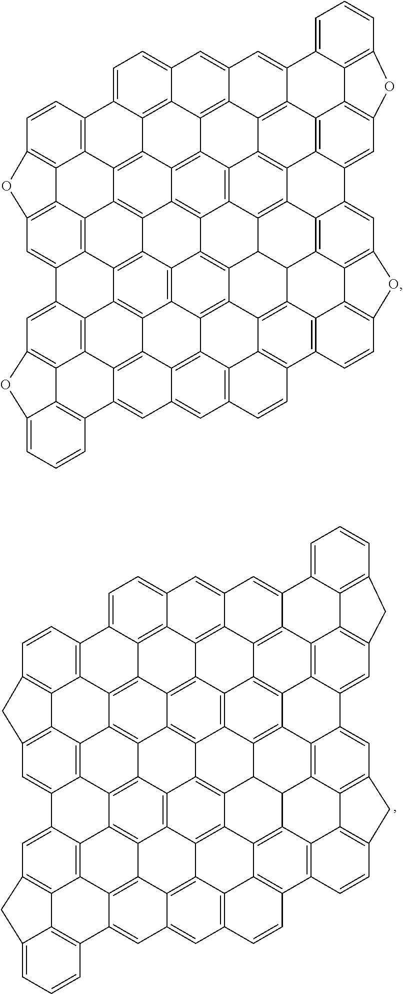

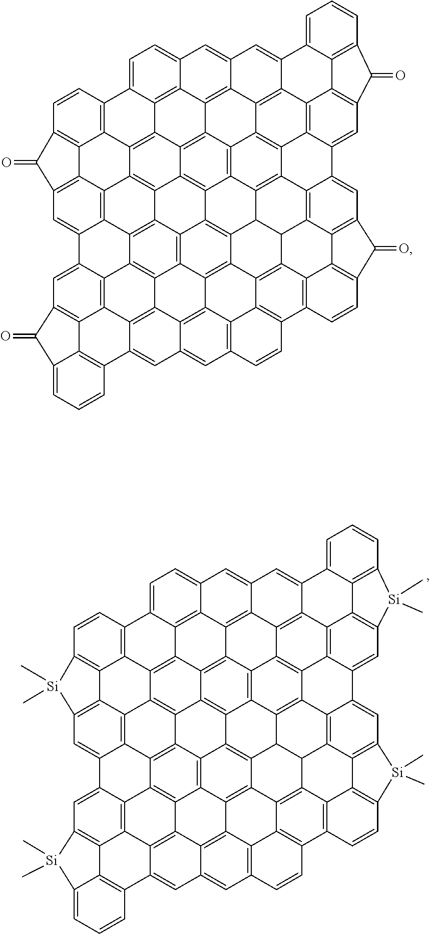

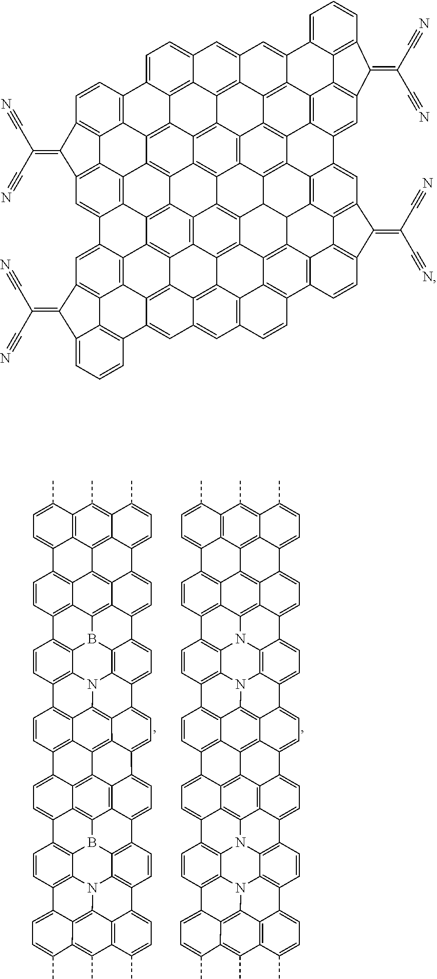

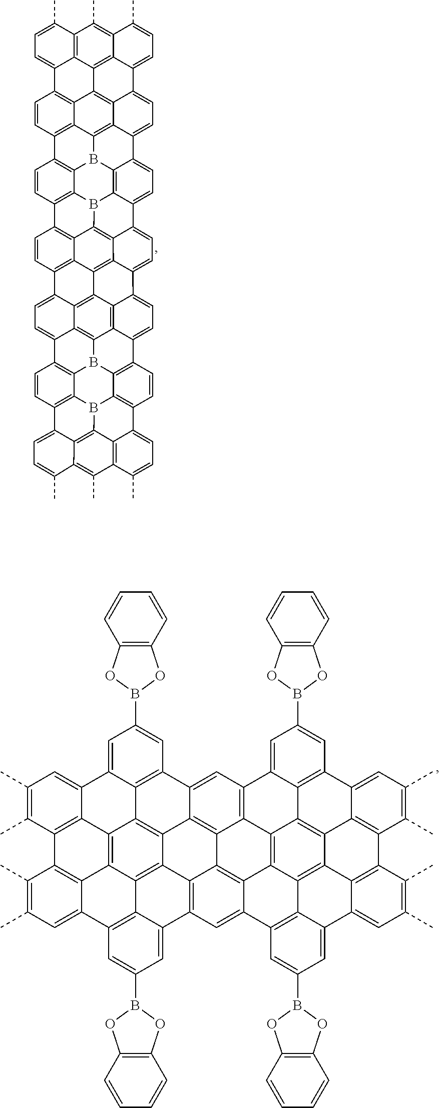

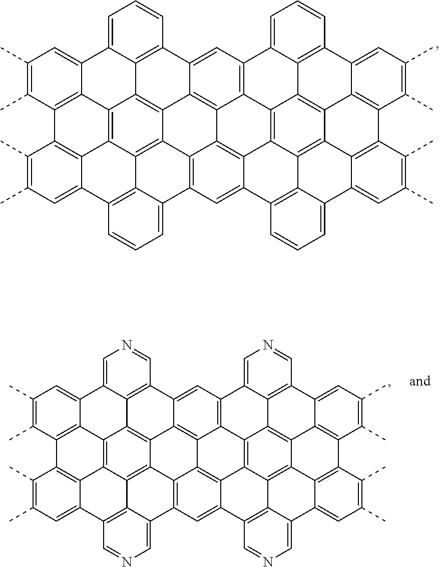

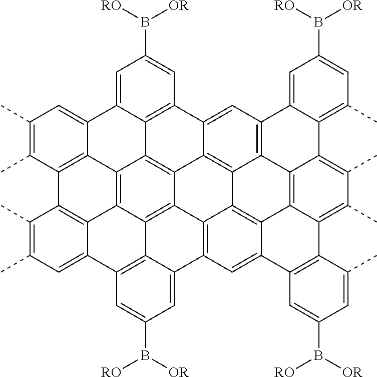

wherein R and R′ are independently selected from H, D, optionally substituted (C₁-C₆)alkyl (e.g., CF₃), optionally substituted hetero-(C₁-C₆)alkyl, optionally substituted (C₁-C₆)alkenyl, optionally substituted hetero-(C₁-C₆)alkenyl, optionally substituted (C₁-C₆)alkynyl, optionally substituted hetero-(C₁-C₆)alkynyl, optionally substituted (C₁-C₆)cycloalkyl, optionally substituted (C₁-C₆)cycloalkenyl, optionally substituted aryl, optionally substituted heterocycle, hydroxyl, halo (e.g., F, Cl, Br, and I), imine, amine (e.g., NH₂ and NR¹₂), amide, nitro, nitroso, nitrile, isocyanate, alkoxide (e.g., O-alkyl and O-ether), ester, carbonyl (e.g., aldehyde, and ketone), carboxyl, thiol, SH, SR¹, thionyl, sulfonyl, SiR¹₃, PR¹₃, PR¹₂ and heterocycle (e.g., pyridine, triazole, pyrimidine, and pyrazine); and

R¹ is selected from an optionally substituted (C₁-C₆)alkyl, an optionally substituted hetero-(C₁-C₆)alkyl, an optionally substituted (C₁-C₆)alkenyl, an optionally substituted hetero-(C₁-C₆)alkenyl, an optionally substituted (C₁-C₆)alkynyl, or an optionally substituted hetero-(C₁-C₆)alkynyl, a cycloalkyl, an aryl, and a heterocycle; and

X is selected from O, S, Se, N—R, P—R², and B—R² where R² is an optionally substituted alkyl, an optionally substituted heteroalkyl, an optionally substituted alkenyl, an optionally substituted heteroalkenyl, an optionally substituted alkynyl, or an optionally substituted heteroalkynyl, a cycloalkyl, an aryl, and a heterocycle. In certain embodiments, any of the foregoing hydrocarbon substituents may have very long carbon chains so as to increase the solubility of the resulting composites by comprising at least 10, 20, 30, 40, or 50 carbon atoms. Please note that where a group includes, e.g., C₁-C₆, the group can comprise 1, 2, 3, 4, 5, or 6 carbon atoms.

The term “hetero-”, as used in this disclosure, refers to chemical group that contain at least 1 non-carbon atom. In one embodiment, the non-carbon atom is selected from the group consisting of N, S and O.

In a further embodiment, the nanostructured composites disclosed herein comprises graphene oxide (GO). Accordingly, any of the graphene derivative structures depicted herein can be oxidized to graphene oxide. Graphene oxide, formerly considered just a precursor for the synthesis of graphene, has begun to find independent applications in water purification and gas separations due to its hydrophilicity, chemical structure, and atomistic pore size diameters. For example, GO membranes have recently been explored as materials for gas separation challenges; interestingly, these studies have shown extreme permeability for H₂ relative to other atmospheric gases such as O₂ and N₂, thus providing a potential avenue for use as an atomically thin, selective barrier layer for sensitive hydrogen storage materials. Graphene oxide is easy dispersible in water and other organic solvents, as well as in different matrixes, due to the presence of the oxygen functionalities. Graphene oxide is often described as an electrical insulator, due to the disruption of its sp2 bonding networks. Functionalization of graphene oxide can fundamentally change graphene oxide's properties. The resulting chemically modified graphenes could then potentially become much more adaptable for a lot of applications. There are many ways in which graphene oxide can be functionalized, depending on the desired application.

In yet a further embodiment, the nanostructured composites disclosed herein comprises reduced graphene oxide (rGO). Accordingly, any of the graphene derivative structures depicted herein can be oxidized and reduced to rGO. The reduction of GO to form reduced graphene oxide results in a dramatic decrease in water permeance while maintaining desirable gas permeability characteristics. There are a number of ways reduction of GO can be achieved, though they are all methods based on chemical, thermal or electrochemical means. Some of these techniques are able to produce very high quality rGO, similar to pristine graphene.

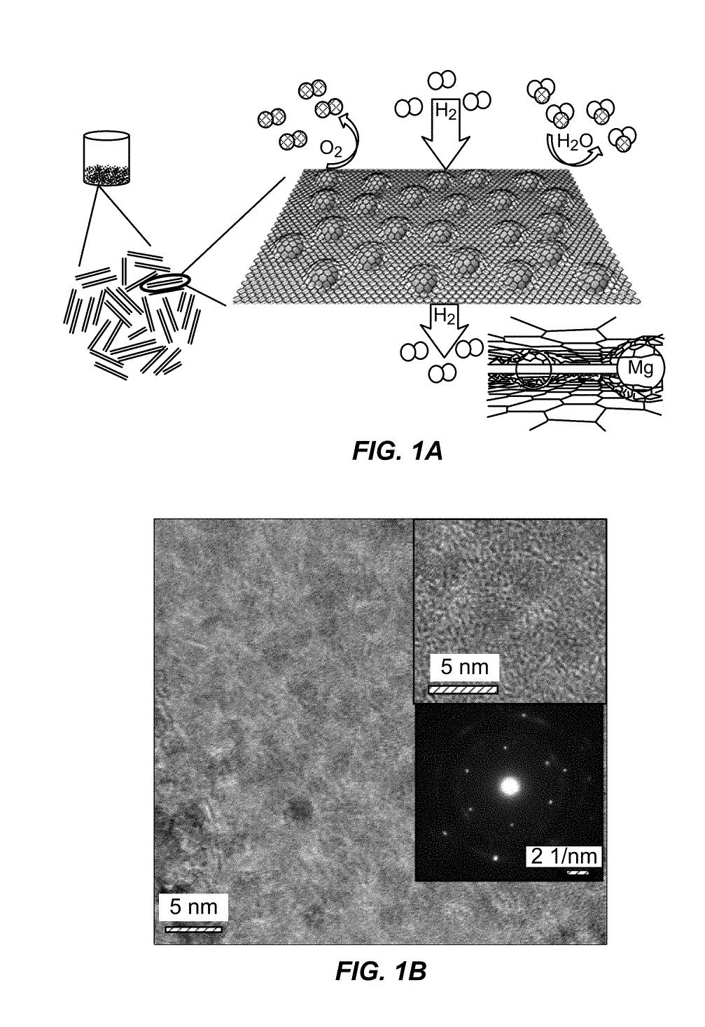

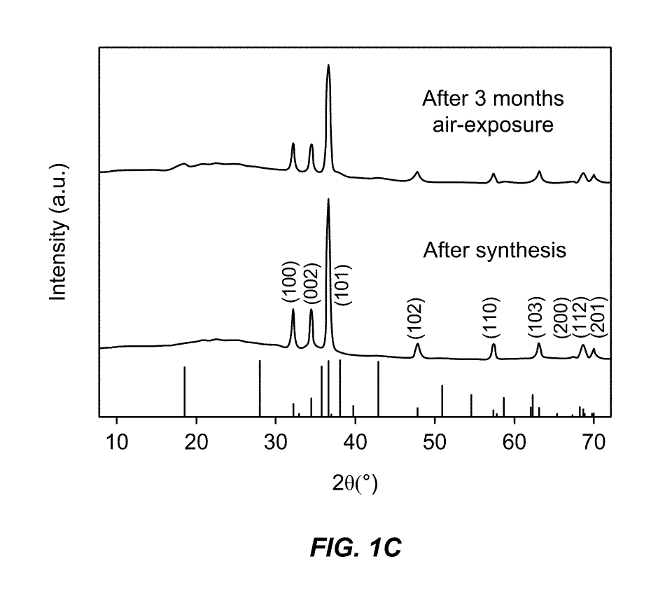

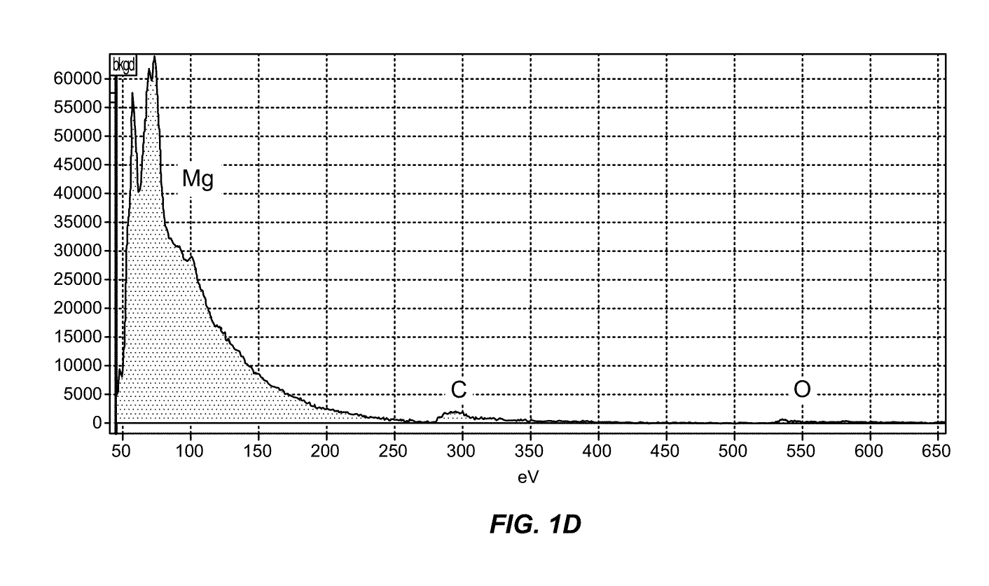

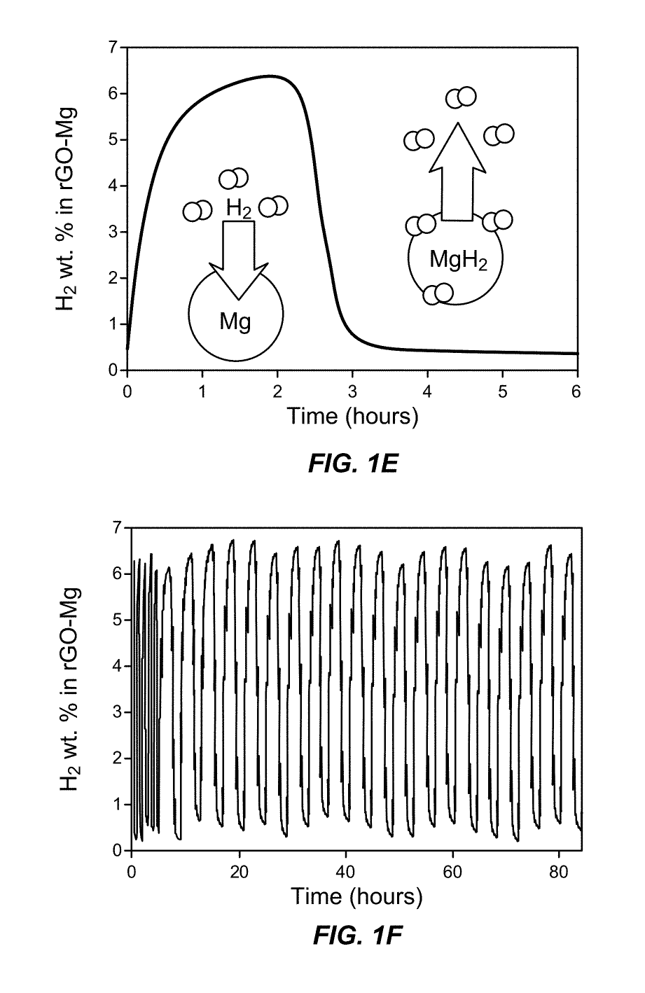

In certain embodiments presented herein, the nanostructured composites of the disclosure are prepared as mixed dimensional laminates of 2D graphene derivatives with metal nanocrystals. The nanostructured composites disclosed herein were found to be especially suited for solid-state hydrogen storage (e.g., See FIG. 1A). For the nanostructure composites disclosed herein, the graphene derivative serves as the atomic limit for barrier layer materials in functional composites, providing the least possible amount of inactive mass for the greatest performance in selective permeability and kinetic enhancement (theoretically up to 98 wt % of Mg in the composite). As illustrated in embodiments presented herein, the graphene derivative sheets of the nanostructured composites disclosed herein function as a protective layer preventing metal nanocrystal oxidation, while still allowing hydrogen to easily penetrate, diffuse along the layers, and be released (e.g., see FIG. 1A). Moreover, in addition to the gas barrier behavior, the graphene derivative layers add functionality to the nanostructured composites by reducing the activation energies associated with hydrogen absorption and desorption, key kinetically limiting steps for traditional metal hydride systems. In this regard, the graphene derivative layers could be considered an ideal encapsulating layer by being atomically thin, providing minimal added mass, and protecting metal nanocrystals from degradation, while imparting functionality and catalytically enhancing rate-limiting hydrogen absorption/desorption events. Additionally, the GNRs and/or sheets of the disclosure by having directed functionality and/or providing specific pendant groups, are capable of providing unique catalytic, surface pooling, strain, and electronic structure modifications that enhance kinetics.

The majority of reported composites consisting of metals and carbon materials are prepared via ball-milling or solidification with either polymers or carbon frameworks. However, ball-milled materials are notoriously polydisperse, which introduces corresponding inhomogeneity in properties. Moreover, energy intensive processes themselves can intrinsically introduce unwanted morphological disruptions and chemical inhomogeneities, all of which detract from performance. By contrast, the methods disclosed herein allow for the densest possible loading of reactive metal nanocrystals safely into a composite material, an important step forward for enhancing the energy density of nanomaterials. In a particular embodiment, the nanostructured composites can be produced by utilizing a direct, one-pot, and co-reduction synthesis method. Accordingly, the pristine, monodisperse metal nanocrystals, and the desired graphene derivative can be simultaneously formed without having to use energy-intensive processing or ligand chemistries. In a further embodiment, the nanostructured composites can be synthesized by a facile solution-based co-reduction method, where the metal ion precursor (e.g., Mg²⁺) is stabilized by graphene oxide, and the GO and metal ions can both be reduced by using a reducing agent. Examples of additional reducing agents include, but are not limited to, lithium naphthalenide, sodium naphthalenide, potassium naphthalenide, hydrazine, thiourea dioxide, NaHSO₃, sodium borohydride, lithium aluminum hydride and thiophene.

The nanostructured composites of the disclosure offer exceptional environmental stability and unsurpassed hydrogen storage capability, exceeding that offered by any other non-cryogenic reversible material. The nanostructured composites disclosed herein exceed 2017 DOE gravimetric- and ultimate full-fleet volumetric-targets for FCEVs. Furthermore, the atomically thin nanostructured composites disclosed herein can be used to simultaneously protect embedded nanocrystals from ambient conditions while also imparting new functionality. The nanostructured composites by comprising zero-valent nanocrystalline metals have wide-ranging applications, including for use in batteries, catalysis, and energetic materials.

The nanostructured composites disclosed herein are ideally suited for storing high volumes of hydrogen in tandem with a fuel cell or internal combustion engine for energy generation for a vehicle. Additionally, the nanostructured composites could be used with material handling equipment, unmanned aerial vehicles or a standalone electricity generation system involving the combination of hydrogen from the composite material and oxygen from the air to produce water and electricity. The nanostructured composites of the disclosure can also be used to separate one or more gases (e.g., hydrogen) from a gaseous mixture. The nanostructured composites of disclosure exhibit a high affinity for H₂. Accordingly, the nanostructured composites of the disclosure are ideally suited for use with gaseous mixtures that contain hydrogen, such as industrial gases (e.g., water gas), gases obtained by partial decomposition of gaseous hydrocarbons such as methane, or natural gases, and waste gases from destructive hydrogenation processes.

The disclosure further provides various devices which can comprise the nanostructured composites disclosed herein. In particular embodiment the devices are gas storage and/or gas separation devices. In another embodiment the disclosure provides for membrane-based separation devices which comprise the nanostructured composites of the disclosure. Membranes have several advantages compared with absorption and adsorption separation processes for gas capture, including a relatively small footprint, reducing the capital costs; no regeneration requirements, thereby reducing the complexity in designing heat-exchange systems; no solvent requirements, making them more environmentally friendly; and higher efficiency of separation owing to a lack of phase change. In general, membranes can be classified based on material (e.g., polymeric, ceramic, or metallic), transport mechanism (e.g., Knudsen diffusion, molecular sieving, or solution-diffusion), or gas selectivity (e.g., H₂-selective). In particular, H₂-selective membranes would be ideally suited for precombustion capture in combustion engines. Accordingly, membranes comprising the nanostructured composites disclosed herein are tailor made for internal combustion engines. Gas selectivity of the nanostructured composites results from hydrogen being able to penetrate through the defect site on the plane of the composites while being generally impervious to other gas molecules. Additionally, gas separation selectivity of nanostructured composites can result from other structural features of the composites (e.g., edge sites, functional groups, defects, etc.)

The following examples are intended to illustrate but not limit the disclosure. While they are typical of those that might be used, other procedures known to those skilled in the art may alternatively be used.

### EXAMPLES

### Example 1

Synthesis of nanostructured composites: The composites of reduced graphene oxide (rGO) and Magnesium (rGO-Mg) were synthesized in a glove box under argon. In order to effectively make a complex with bis(cyclopentadienyl)magnesium (Cp₂Mg), graphene oxide (GO) GO was ball-milled for 10 minutes prior to use. A lithium naphthalenide solution was then prepared by dissolving naphthalene (2.40 g, 0.0187 mol) in THF (120 mL), followed by the immediate addition of lithium (0.36 g, 0.0253 mol). The resulting solution was dark green in color. A GO suspension was made by dispersing GO (6.25 mg) in THF (12.5 mL) under argon. The GO suspension was then sealed in a container and sonicated for 1.5 hours. A Cp₂Mg solution was next made by dissolving Cp₂Mg (2.31 g; 0.015 mol) in THF (22.5 mL). This Cp₂Mg solution was then added to GO solution and stirred for 30 min. The resulting GO/Cp₂Mg solution was added to the lithium naphthalenide solution and stirred magnetically for 2 hours. The resulting product was centrifuged (10,000 rpm, 20 min) and washed twice with THF (10,000 rpm, 20 min), followed by drying in vacuo overnight.

Characterization and Instrumentation: High-resolution transmission electron microscopy was performed using JEOL 2100-F Field-Emission Analytical Transmission Electron operated at 120 kV and equipped with Oxford INCA energy dispersive electron x ray spectrometer and Tridiem Gatan imaging Filter and spectrometer. The powder samples were dispersed on lacy carbon grids from THF solutions. Elemental analysis of the EELS and EDS spectra was performed using Digital Micrograph software (Gatan Inc.) X-ray diffraction (XRD) patterns were acquired with a Bruker AXS D8 Discover GADDS X-Ray Diffractometer, using Cu Kα radiation (A=0.154 nm). Hydrogen absorption/desorption measurement was performed, using a HyEnergy PCT Pro-2000 at 15/0 bar of H₂ at different temperatures. X-ray Absorption Near-Edge Structure Spectroscopy (XANES) was performed on Beamline 8.0.1.3 at the Advanced Light Source (ALS). The energy resolution at Carbon K-edge is set to 0.1 eV and the experimental chamber had a base pressure better than 1×10⁻⁸ torr. A HOPG reference sample was measured before and after all XANES experiments for energy calibration. The XANES spectra were recorded using Total Electron Yield (TEY) and Total Fluorescence Yield (TFY) detection modes. The Raman spectra of GO and rGO-Mg samples were collected, using Horiba Jobin Yvon LabRAM ARAMIS automated scanning confocal Raman microscope with a 532 nm excitation source, and X-ray Photoelectron spectra were obtained via PHI 5400 X-ray Photoelectron Spectroscopy (XPS) System with Al Kα. The Mg content in the composite was determined by Inductively Coupled Plasma-Optical Emission Spectroscopy (ICP-OES) at ALS Life Sciences Division & Environmental.

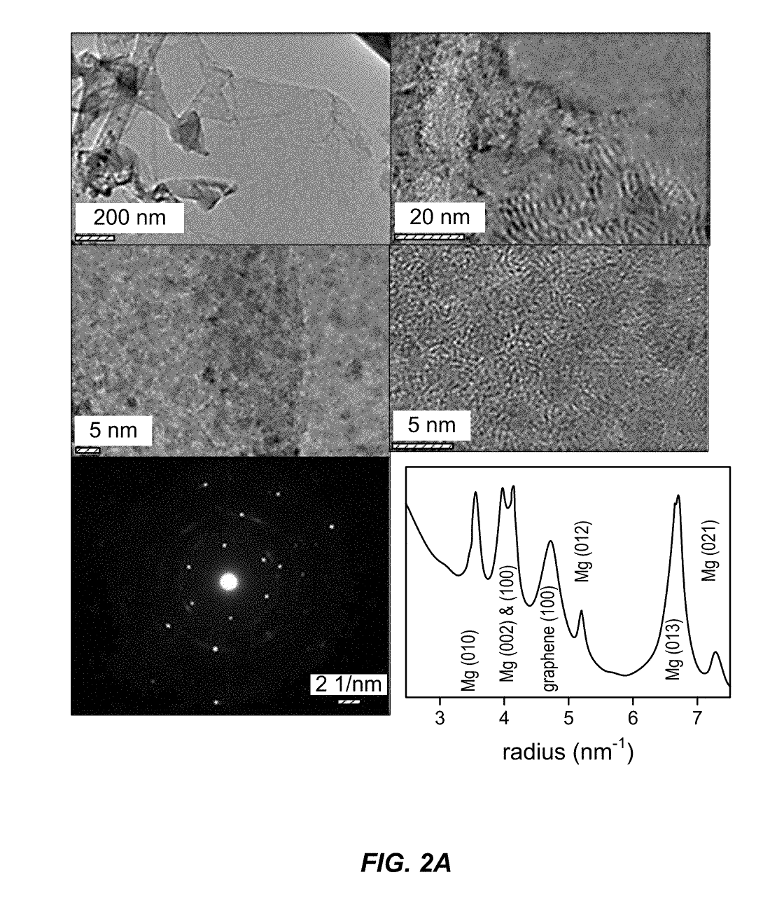

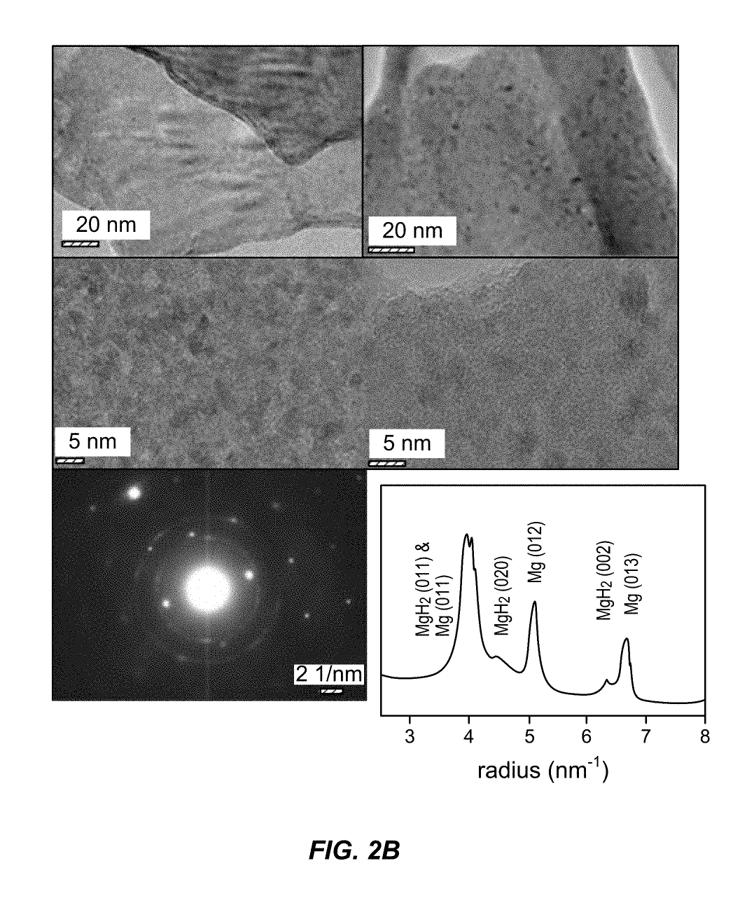

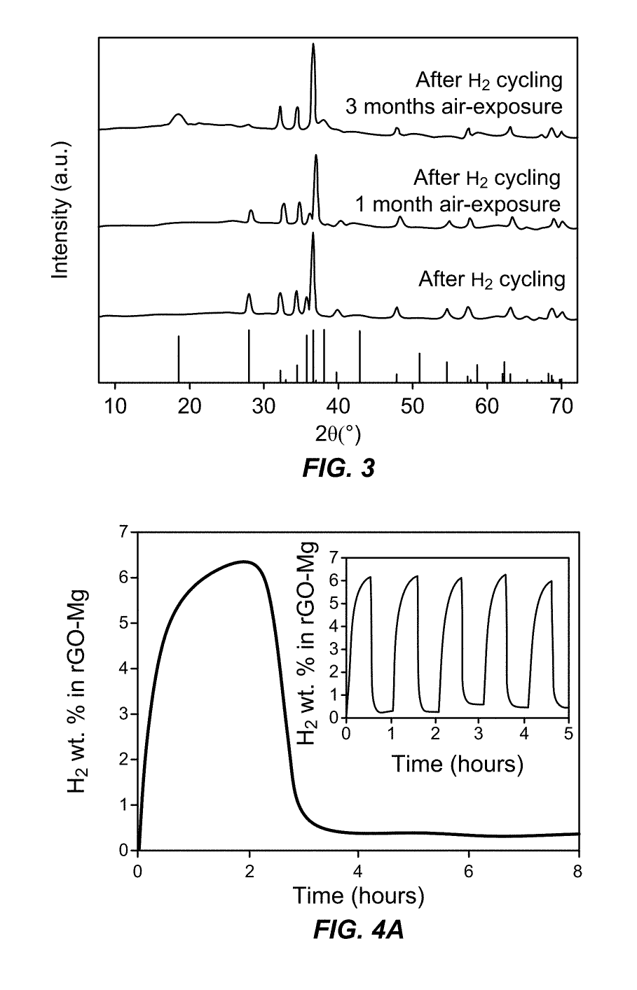

Structural Characterization of the Nanostructured Composites. The obtained rGO-Mg was characterized via transmission electron micrograph (TEM) and x-ray diffraction (XRD) (see FIG. 1B and C). The magnesium nanocrystals were found to be about 3.26 nm in diameter (3.26 nm±0.87 nm) based on the TEM images. Thus, in direct contrast to other metal hydrides prepared by conventional method such as ball-milling, the magnesium nanocrystals described herein are fine monodisperse nanocrystals. EELS measurements indicated that the composites comprised an unexpectedly high density of magnesium crystals, in-fact the highest reported to date for composites. Despite containing such a dense packing of Mg nanocrystals, the nanostructured composites were remarkably air-stable. To investigate the limits of stability, rGO-Mg samples were exposed to air and characterized over time by XRD and TEM (see FIG. 1C and FIG. 2); incredibly even after three months of air exposure, the nanocrystals remained almost entirely zero-valent crystalline Mg, while showing invasion of only a low intensity Mg(OH)₂ peak after three months of exposure (see FIG. 3). Moreover, to demonstrate the innovativeness of the nanostructured composites disclose herein, the composites were completely exposed to air, and then hydrogen cycling was performed. This is not possible with any other reported hydride materials with comparable storage densities.

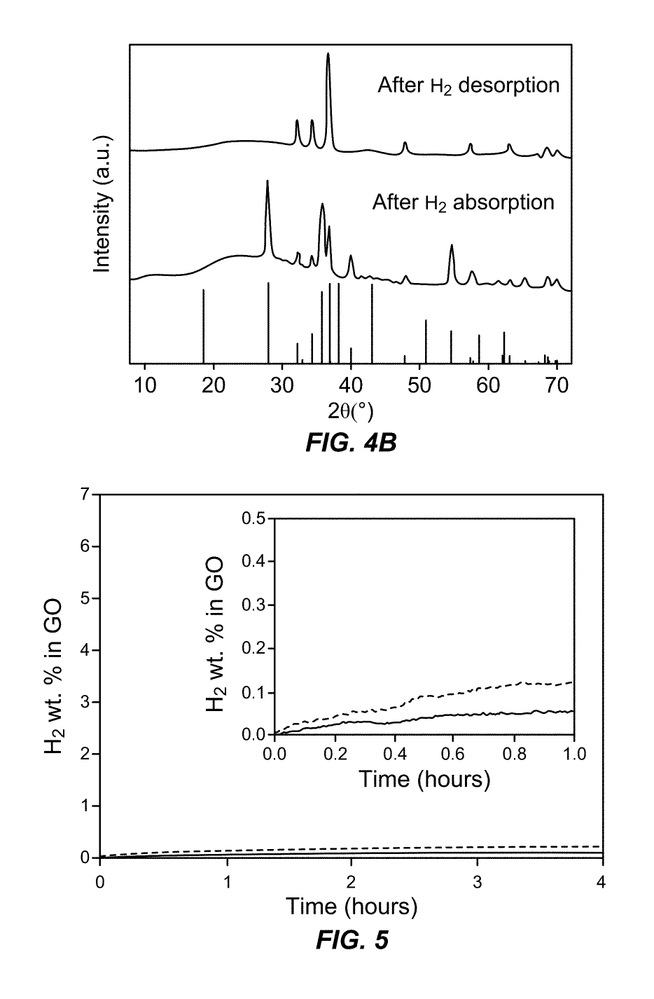

Hydrogen Absorption and Desorption Characteristics of the Nanostructured Composites: The nanostructured composites were tested using a Sieverts PCT-Pro instrument at 15 bar H₂ and 0 bar, respectively (see FIG. 4A). Hydrogen uptake was immediate, and formation of MgH₂ was confirmed by XRD (see FIG. 4B) and electron diffraction (see FIG. 2). The hydrogen absorption capacity of the composite was 6.38 wt % and 0.103 kg H₂/L in the total composite, far exceeding desired 2017 DOE gravimetric target (5.5 wt %) and ultimate full-fleet volumetric target (0.070 kg H₂/L) for FCEV applications. This corresponds to 7.42 wt % H₂ in Mg nanocrystals, which is 97% of the theoretical value (7.6 wt %). Given that this is the atomically thin limit for encapsulation, this is the densest packing of metal hydride nanocrystals possible, leading to optimized storage density. Furthermore, hydrogen was readily desorbed up to 6.05 wt % in the composite, thus demonstrating excellent reversibility. To verify that the hydrogen absorption was not caused by the presence of GO in the composite, control studies using only GO were conducted and exhibited minimal (<0.2 wt % in GO) absorption at 200° C. and 250° C. (see FIG. 5). This is a negligible contribution, given that the amount of GO in the composites is <2 wt % overall.

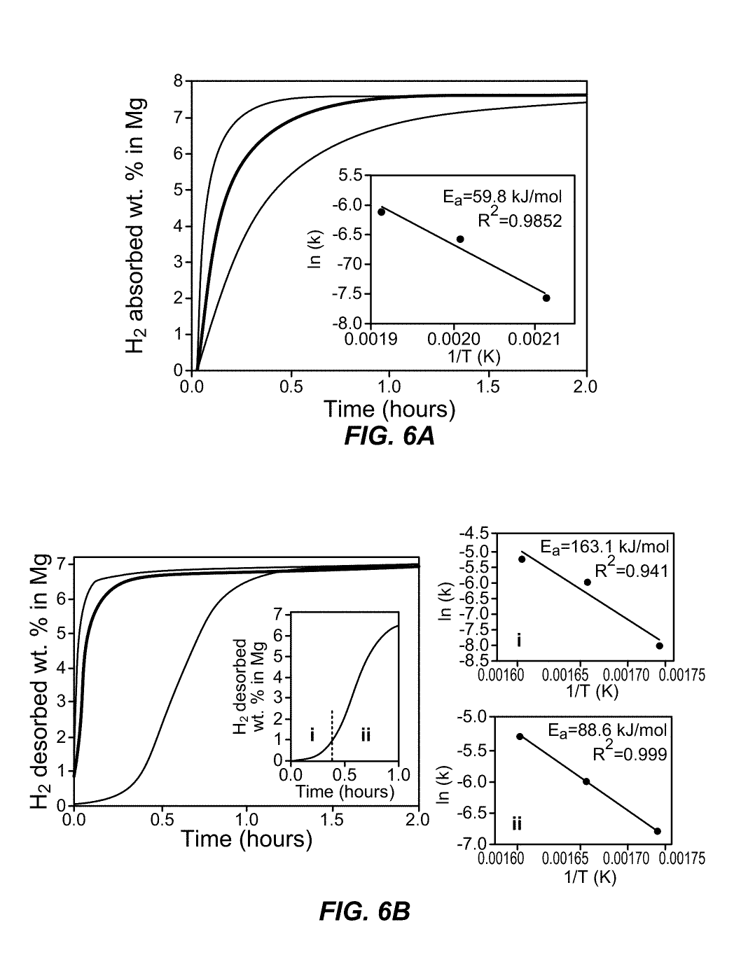

Kinetics of the Hydrogen Absorption and Desorption for Nanostructured Composites: To analyze the kinetics, the activation energy (Eₐ) for hydrogen absorption/desorption was determined from measurements at three different temperatures, fitting the result with the Johnson-Mehl-Avrami model (see FIG. 6).

All measurements were performed with one sample, and the obtained data were fit, using the Johnson-Mehl-Avrami equation (EQ. 1)

[−ln(1−x)]^{1/n}=kt (EQ. 1)

where x is the fraction of Mg or MgH₂ hydrogenated or dehydrogenated, k is the reaction rate, t is time, and n is the reaction exponent. For the absorption measurement, the best linear behaviour was acquired with n=1, implying nucleation and growth along one-dimension. The activation energy of absorption was calculated to be 59.8 kJ/mol with R²=0.9852. For the desorption measurement, however, a different behavior was observed at 300° C. Unlike 325° C. and 350° C., the curve shape changed upon approximately 1 wt % of H₂ desorption for 300° C.; hence, the data at 300° C. was separated into two regions, before and after 1 wt % desorption (labeled as region (i) and (ii), respectively, in the FIG. 6B inset), for an accurate analysis. The best linear behavior was obtained with n=1 for 325° C. and 350° C., while n=3 and n=1 for 300° C., before (i) and after (ii) 1 wt % desorption, respectively. Different activation energies were obtained, using two data regions, which are 163.1 kJ/mol (R²=0.941) and 88.6kJ/mol (R²=0.999). The curve fitting had higher R² value when the data region with n=1 was used. It can be inferred that hydrogen was desorbed via one-dimensional growth after the fast nucleation, above a certain temperature, while the slow nucleation was done until 1 wt % of hydrogen was desorbed, followed by one-dimensional growth at 300° C. The Eₐ values were 59.8 kJ/mol and 88.6 kJ/mol for absorption and desorption, respectively, consistent with 1-dimensional nucleation and growth as shown previously.

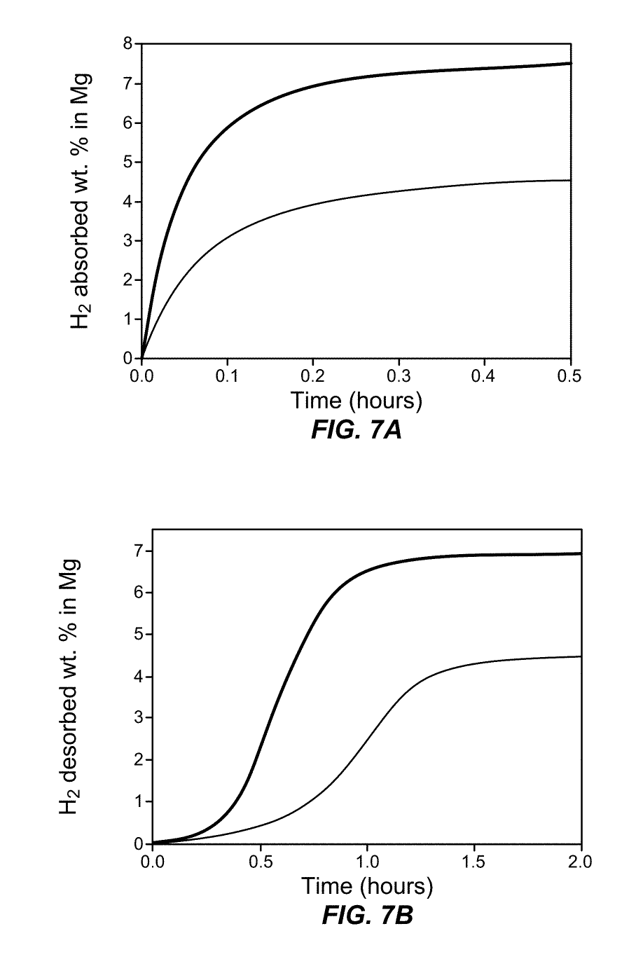

Incredibly, these kinetics are comparable to transition metal-catalyzed bulk metal-hydride systems, and the overall capacity and kinetics greatly surpass the best environmentally robust samples made up to date. The kinetic performance of the materials is likely due to the unique features of the composite: the nanoscale size of the magnesium crystals is comparable to diffusion lengths and enables near complete conversion to the metal hydride (97% of theoretical value), and the interaction of the magnesium nanocrystals with the rGO layers protects against invasion of oxygen while enabling rapid surface diffusion of hydrogen, enhancing kinetics. Indeed, the nanostructured composites hydrogen absorption/desorption kinetics is faster than Mg-polymer composites containing nanocrystals of similar size (see FIG. 7). The hydrogen absorption/desorption properties of rGO-Mg were compared with Mg-PMMA which has a similar size of Mg nanocrystals encapsulated by poly(methyl methacrylate) (PMMA). The enhancement of both hydrogen capacity and sorption kinetics was observed for the nanostructured rGO-Mg composites; clearly, the presence of the rGO-layers has a beneficial effect on sorption and desorption kinetics.

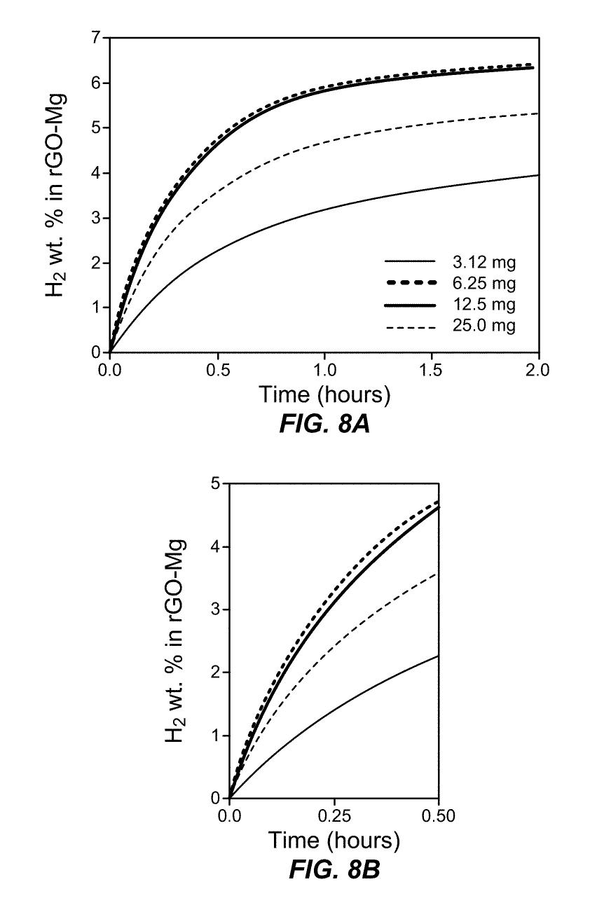

Consistent with previous studies, the diffusion of hydrogen atoms was facilitated by the interaction between magnesium and carbon layers, enhancing both the hydrogen capacity and kinetics of the interaction between magnesium and hydrogen (see FIG. 8). The amount of GO in the composite was varied in order to examine the effect of mass fraction of rGO on sorption behavior. Interestingly, relative to the reported abundance of rGO, both additional and less GO in the synthesis resulted in reduced hydrogen capacity and poorer kinetics. Based upon these results, it was observed that the catalytic effect of rGO on sorption was diminished when less GO was used, while a larger amount of GO could hinder hydrogen diffusion into and out of the Mg nanocrystals by increasing the diffusion path length. Consequently, there exists an optimum weight percent range of GO for optimized performance of the nanolaminates, where rGO prevents Mg nanocrystals from oxidizing, while also enhancing the kinetics and maximizing hydrogen capacity.

Remarkably, 80% of H2 was absorbed in 7.2 minutes and desorbed in 3.6 minutes at 250° C/350° C., respectively, and a full deep charge/discharge cycle could be completed within one hour (e.g., see FIG. 4A inset). The capacity and kinetics were well-preserved during further cycles. Importantly, the magnesium nanocrystal size and size distributions were well preserved after several absorption/desorption cycles without sintering or grain growth (see FIG. 2). While bulk metal hydrides are susceptible to mechanical fracture and cracking due to the large volume expansion upon hydriding (ca. 33% from Mg to MgH₂), the high Young's modulus of rGO enables it to robustly encase the Mg nanocrystals and prevent macroscale sintering.

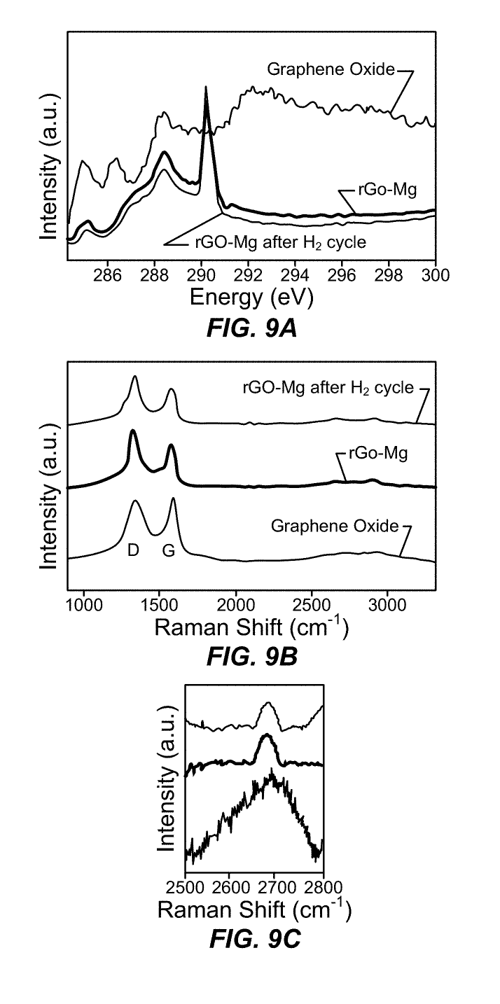

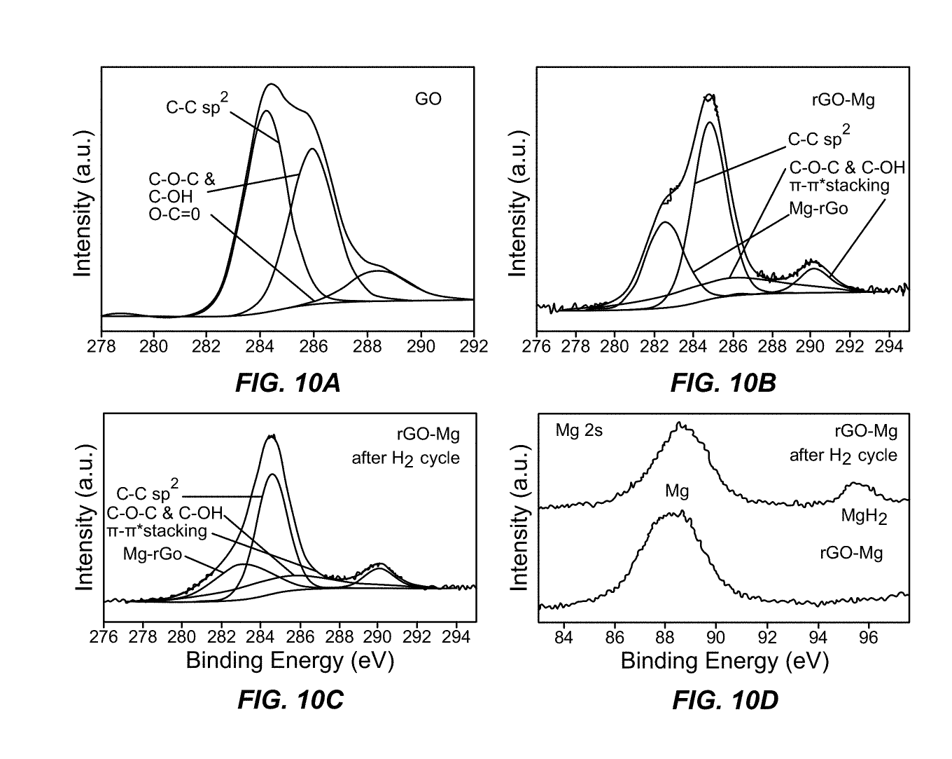

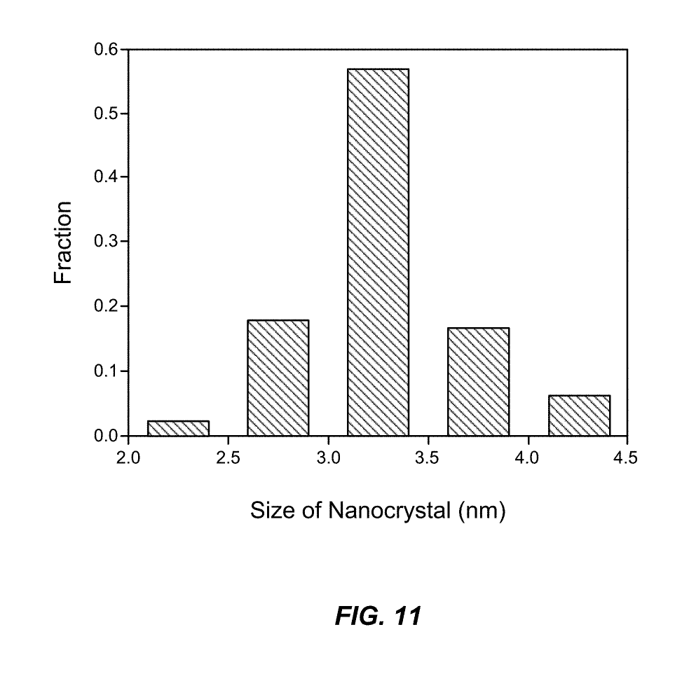

Assays to look at the interactions between rGO and Mg nanocrystals. X-ray absorption near-edge structure (XANES) measurement was performed to probe the interactions between rGO and Mg nanocrystals (see FIG. 9A). Compared to GO, increased intensity of the carbon K-edge at 288.4 eV and 290.3 eV were observed, corresponding to carbon atoms attached to oxygen or other oxygen-containing chemical species. From this, it was inferred that the nanostructured composites are uniquely stabilized by the formation of interfacial Mg—O—C bonds forged during synthesis. It is believed that these bonds provide the bases for the exceptional stability of the composites. The structural evolution of GO during synthesis and hydrogen cycling was studied using Raman Spectroscopy (see FIG. 9B-C). The intensity ratio of D and G peaks (I(D)/I(G)) increased after rGO-Mg synthesis, indicating that the average domain size of sp² hybridized regions was decreased as GO was reduced. The 2D peak, whose position and shape depends on the number of graphene layers, shifted to lower frequency (2701 cm⁻¹ to 2685 cm⁻¹) and its full width at half maximum (FWHM) also decreased upon the formation of rGO-Mg (see FIG. 9C). This suggests that few, if any, isolated multilayers of rGO exist in the composite, and that most rGO layers are actively wrapping Mg nanocrystals. No change was observed in the Raman spectra of freshly synthesized rGO-Mg in comparison to samples studied after hydrogen cycling. Importantly, I(D)/I(G) ratios remained consistent as well (1.370 after synthesis and 1.337 after cycling), indicating that the defect density, a key attribute of rGO responsible for selective hydrogen transport, was well-maintained even after several hydrogen absorption and desorption cycles. Additionally, the chemical environment of GO and rGO-Mg were investigated via X-ray photoelectron spectroscopy (XPS) (see FIG. 10). Peaks associated with oxygen-containing functional groups in the GO are diminished after the formation of rGO-Mg, confirming reduction of GO. The rGO-Mg composite contained an additional peak at 282.5 eV, which is attributed to the interaction between carbon species and metal particles, corresponding to the interaction of rGO and Mg nanocrystals. Furthermore, a prominent π-π* stacking peak was observed at 290.1 eV, resulting from Mg nanocrystal wrapping which was also observed by TEM (see FIG. 2). In the Mg 2s spectrum, one additional peak appears in the higher energy region after hydrogen absorption, implying a new chemical state, consistent with MgH₂.

### Example 2

Characterization and Instrumentation: X-ray diffraction (XRD) patterns were acquired with a Bruker AXS D8 Discover GADDS X-Ray Diffractometer, using Cu Kα radiation (A=0.154 nm). Hydrogen absorption/desorption measurement was performed, using a HyEnergy PCT Pro-2000 at 15/0 bar of H₂ at different temperatures. The Raman spectra of GNR and GNR-Mg samples were collected, using Horiba Jobin Yvon LabRAM ARAMIS automated scanning confocal Raman microscope with a 532 nm excitation source.

Synthesis of nanostructured GNR-Mg composites: The composites of graphene nanoribbons (GNR) and Magnesium (GNR-Mg) were synthesized in a glove box under argon. A lithium naphthalenide solution was then prepared by dissolving naphthalene (2.40 g, 0.0187 mol) in THF (120 mL), followed by the immediate addition of lithium (0.36 g, 0.0253 mol). The resulting solution was dark green in color. A GNR suspension was made by dispersing GNR (6.25 mg) in THF (12.5 mL) under argon. The GNR suspension was then sealed in a container and sonicated for 1.5 hours. A Cp₂Mg solution was next made by dissolving Cp₂Mg (2.31 g; 0.015 mol) in THF (22.5 mL). This Cp₂Mg solution was then added to GNR solution and stirred for 30 min. The resulting GNR/Cp₂Mg solution was added to the lithium naphthalenide solution and stirred magnetically for 2 hours. The resulting product was centrifuged (10,000 rpm, 20 min) and washed twice with THF (10,000 rpm, 20 min), followed by drying in vacuo overnight.

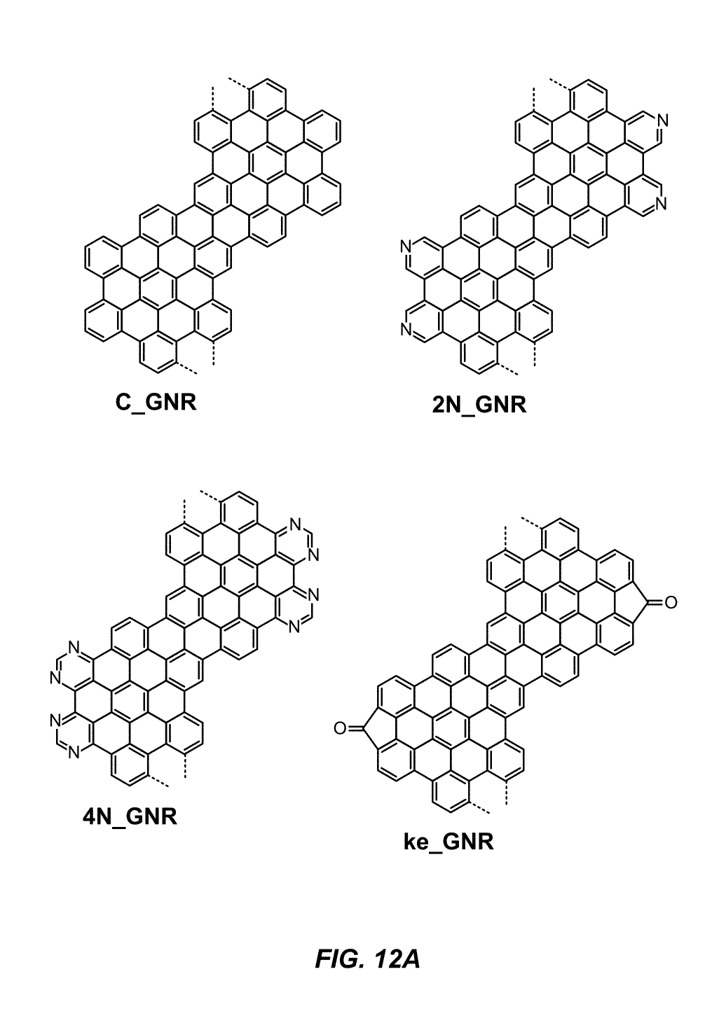

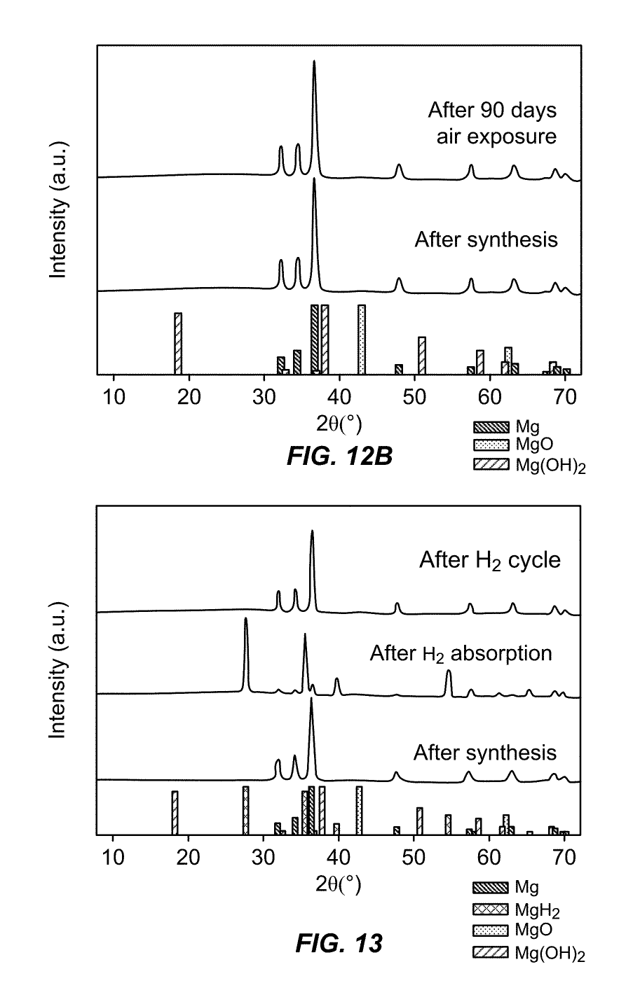

Structural Characterization of the Nanostructured Composites. The obtained GNR-Mg was characterized via x-ray diffraction (XRD) (see FIG. 12B). Despite containing such a dense packing of Mg nanocrystals, the nanostructured composites were remarkably air-stable. To investigate the limits of stability, GNR-Mg samples were exposed to air and characterized over time by XRD (see FIG. 12B). Incredibly even after three months of air exposure, the nanocrystals remained almost entirely zero-valent crystalline Mg.

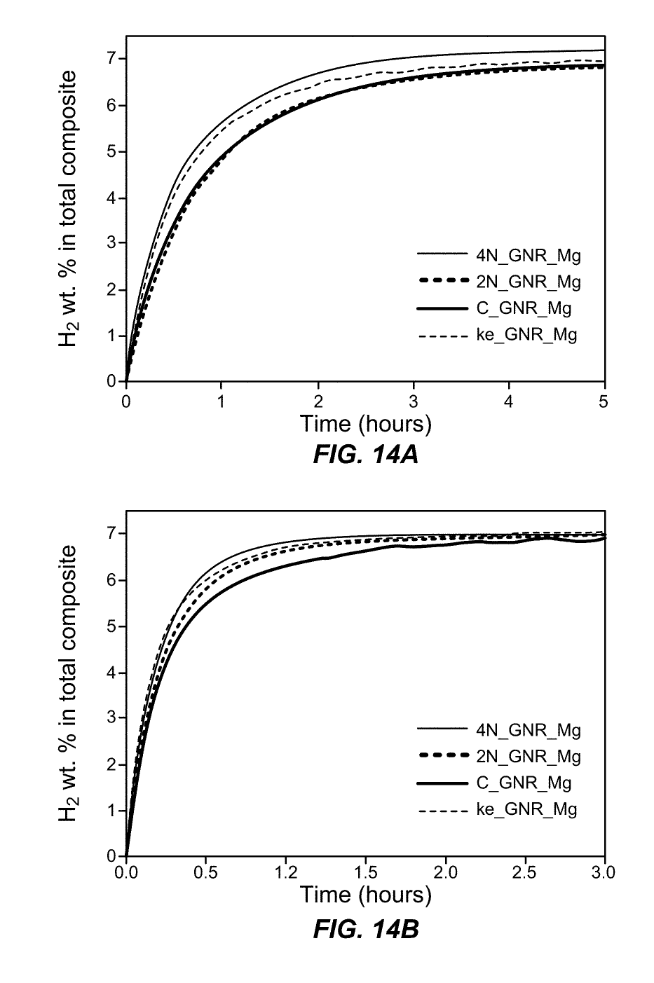

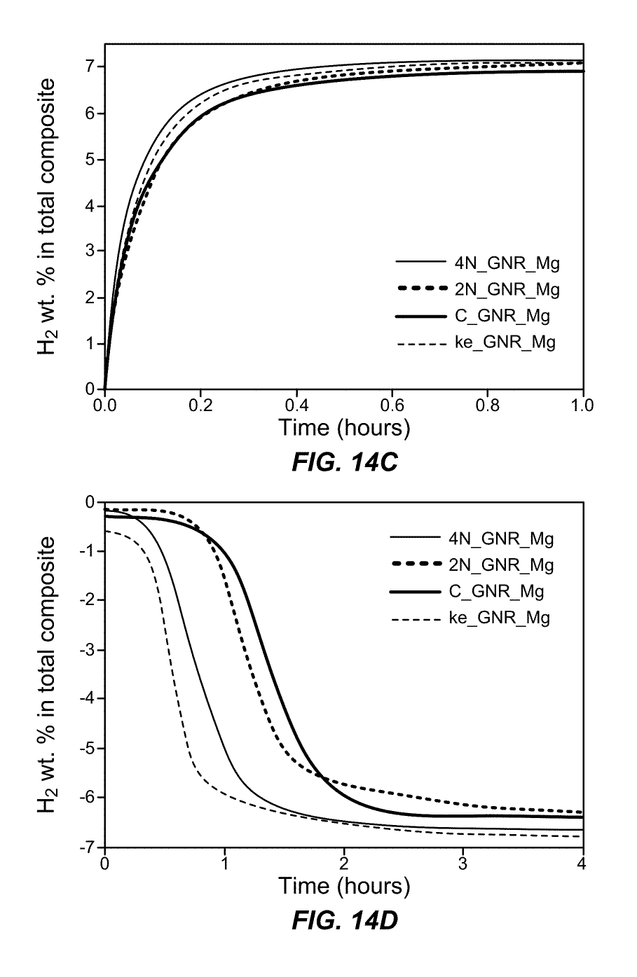

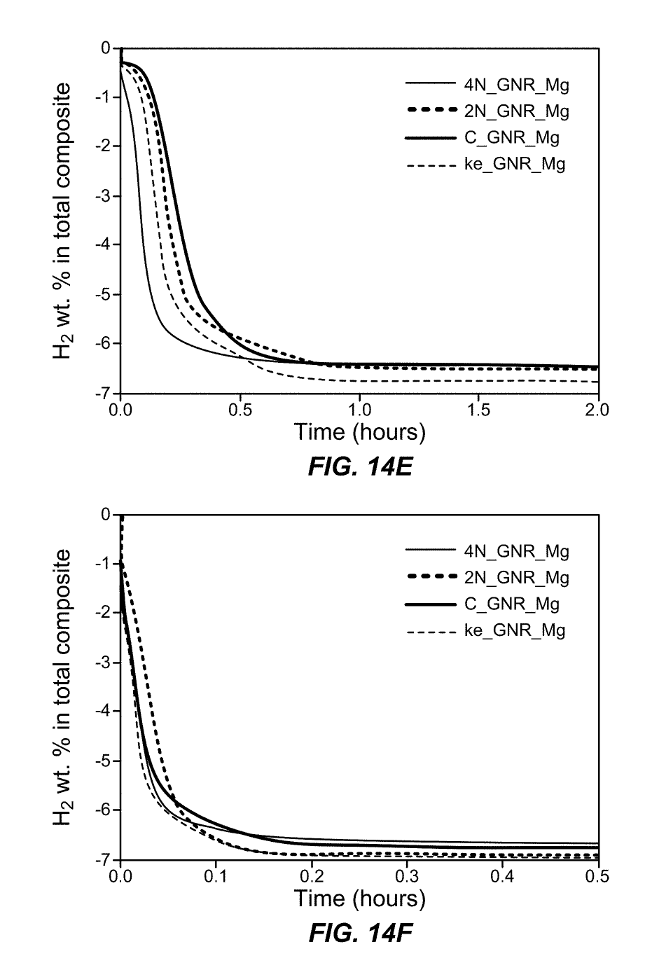

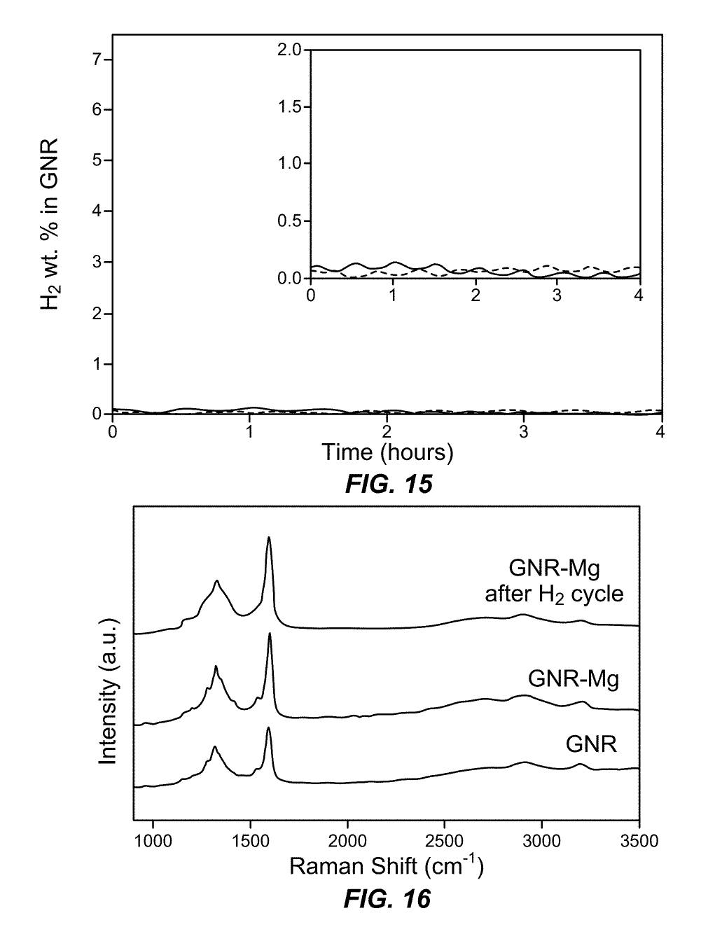

Hydrogen Absorption and Desorption Characteristics of the Nanostructured Composites: The nanostructured composites were tested using a Sieverts PCT-Pro instrument at 15 bar H₂ and 0 bar, respectively (see FIG. 14). Hydrogen uptake was immediate, and formation of MgH₂ was confirmed by XRD (see FIG. 13). The maximum hydrogen absorption capacity of the composite was 7.28 wt % in the total composite, far exceeding desired 2017 DOE gravimetric target (5.5 wt %) for FCEV applications. Given that this is the atomically thin limit for encapsulation, this is the densest packing of metal hydride nanocrystals possible, leading to optimized storage density. Furthermore, hydrogen was readily desorbed up to 7.00 wt % in the composite, thus demonstrating excellent reversibility. To verify that the hydrogen absorption was not caused by the presence of GNR in the composite, control studies using only GNR were conducted and exhibited minimal (<0.2 wt % in GNR) absorption at 200° C. and 250° C. (see FIG. 15). This is a negligible contribution, given that the amount of GNR in the composites is <2 wt % overall.

The capacity and kinetics were well-preserved during further cycles. Importantly, the magnesium/magnesium hydride nanocrystal structures were well preserved after several absorption/desorption cycles without oxidation (see FIG. 12B and FIG. 13). While bulk metal hydrides are susceptible to mechanical fracture and cracking due to the large volume expansion upon hydriding (ca. 33% from Mg to MgH₂), the high Young's modulus of GNR enables it to robustly encase the Mg nanocrystals and prevent oxidation.

A number of embodiments have been described herein. Nevertheless, it will be understood that various modifications may be made without departing from the spirit and scope of this disclosure. Accordingly, other embodiments are within the scope of the following claims.

1. A nanostructured composite comprising sheets or layers of graphene derivatives or graphene nanoribbons and a plurality of metal nanocrystals located between and in contact with the sheets or layers of the graphene derivatives or graphene nanoribbons, wherein the nanostructured composite is capable of reversibly adsorbing one or more gases and wherein the metal nanocrystals comprise a metal which remains at a zero valence state after exposure to oxygen and/or moisture.

2. (canceled)

3. The nanostructured composite of claim 1, wherein the plurality of metal nanocrystals comprise a metal selected from beryllium, magnesium, aluminum, calcium, scandium, titanium, vanadium, chromium, manganese, iron, cobalt, nickel, copper, zinc, and tin.

4. The nanostructured composite of claim 3, wherein the plurality of metal nanocrystals comprise magnesium.

5. The nanostructured composite of claim 1, wherein the plurality of metal nanocrystals have a diameter from 1 nm to 20 nm.

6. The nanostructured composite of claim 5, wherein the plurality of metal nanocrystals have a diameter from about 2 nm to 4.5 nm.

7. The nanostructured composite of claim 1, wherein the graphene derivatives are selected from one or more of the following structures: 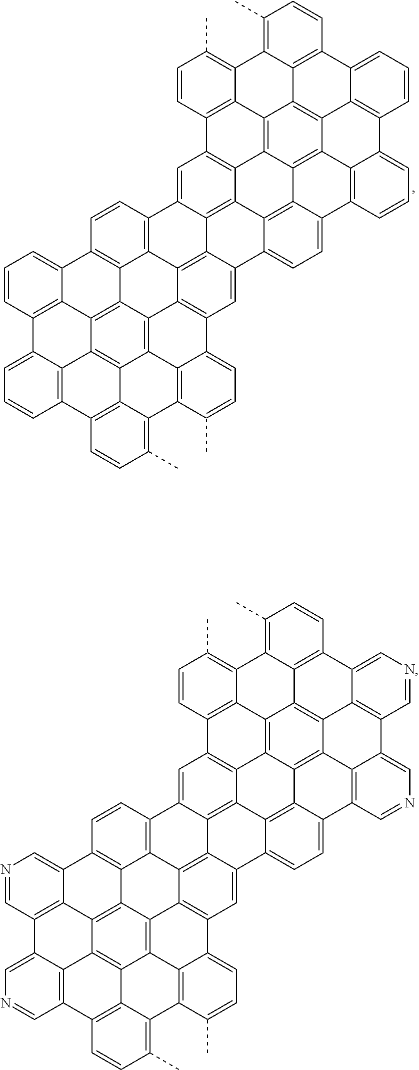 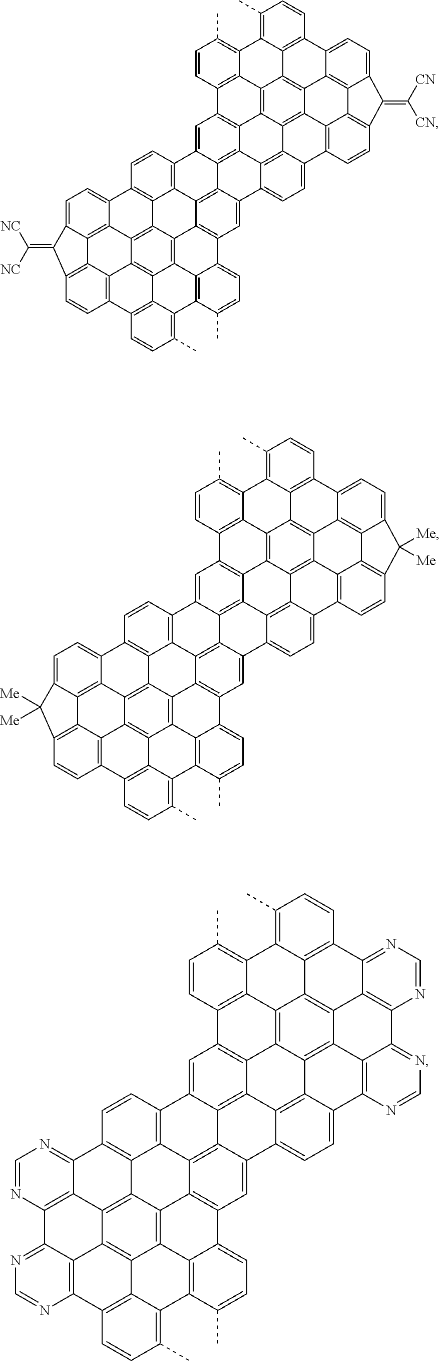 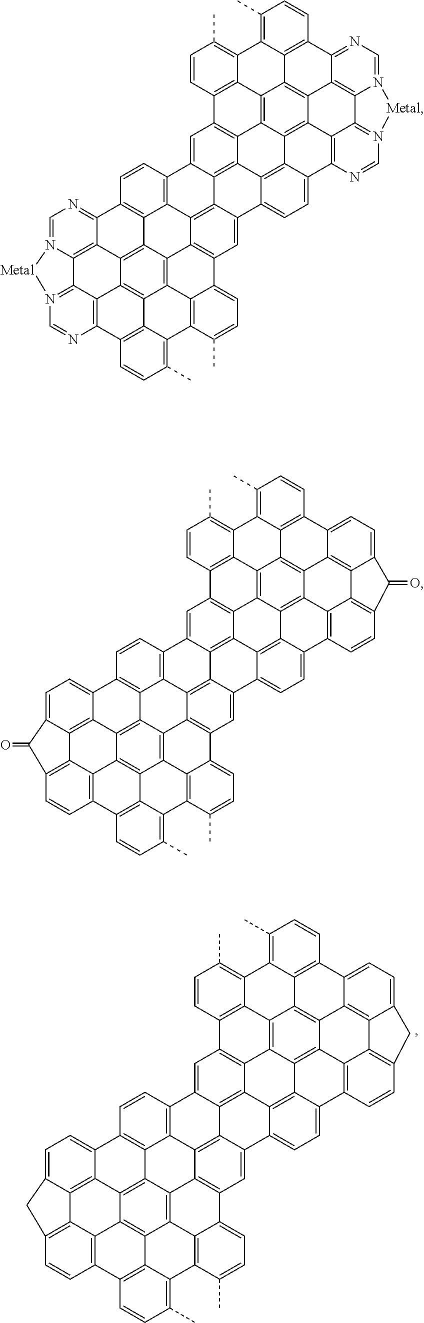 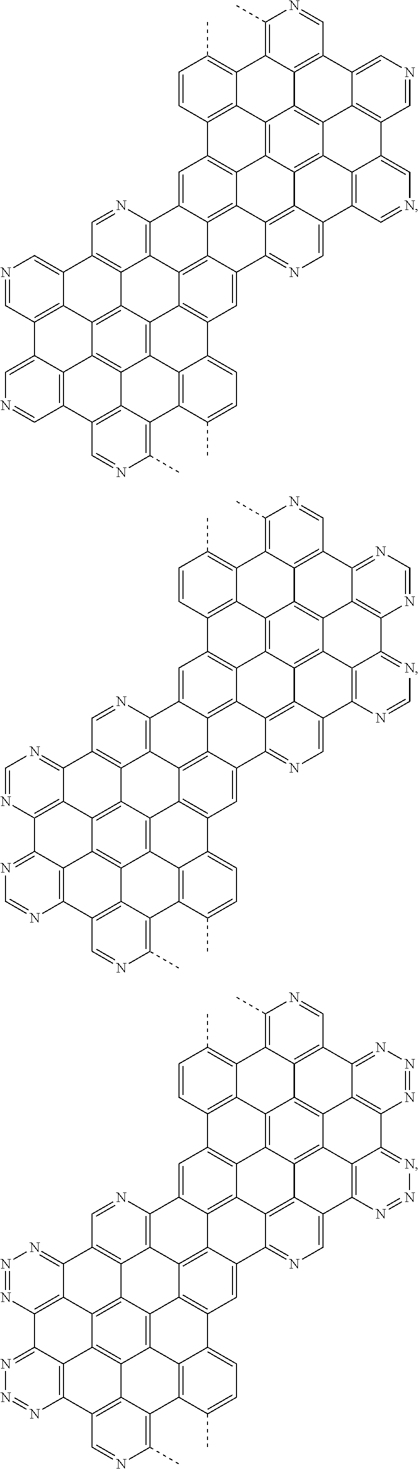 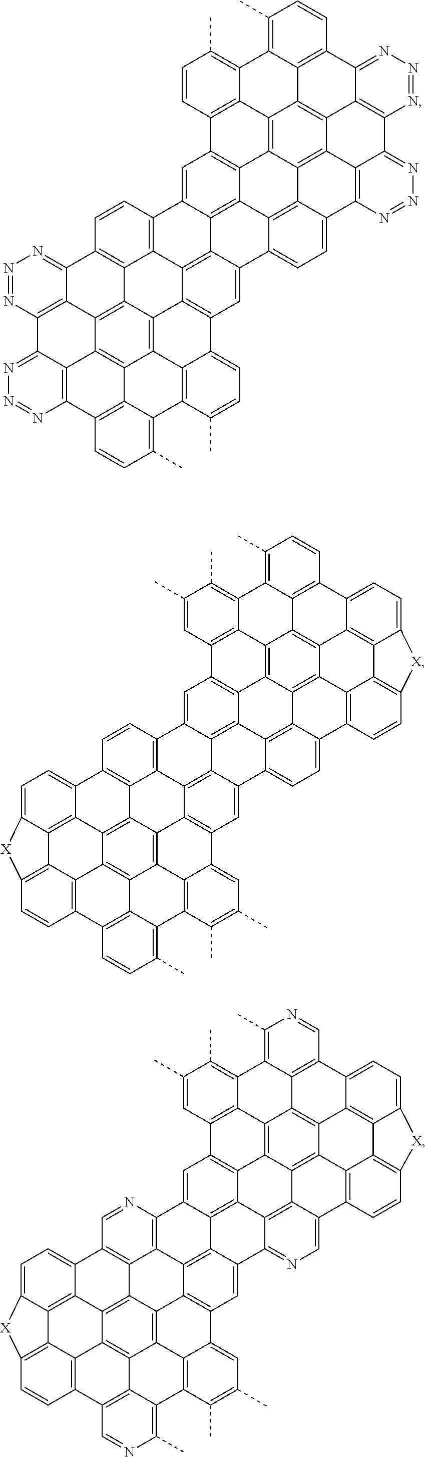 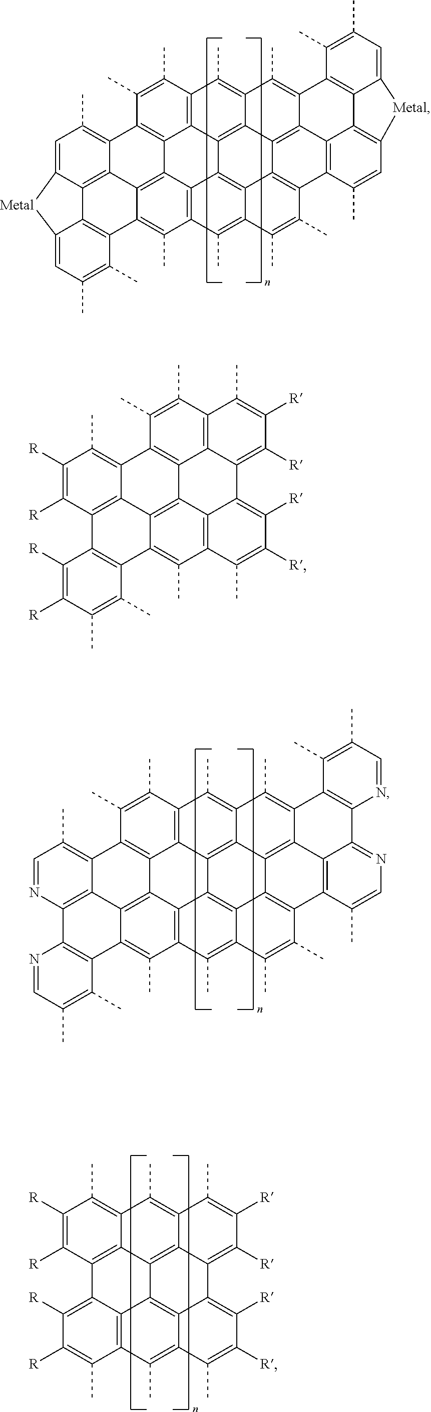 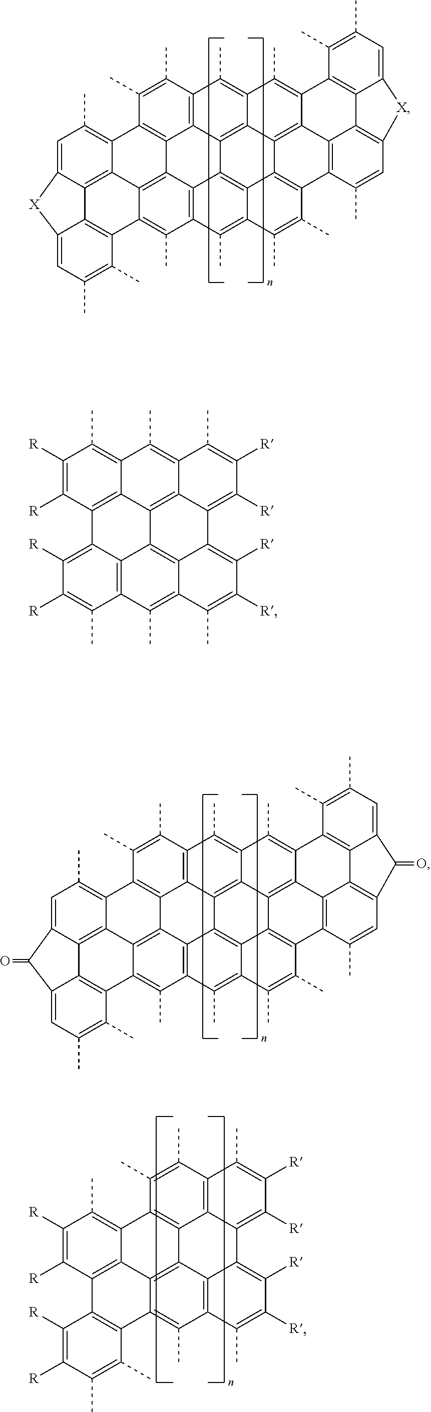 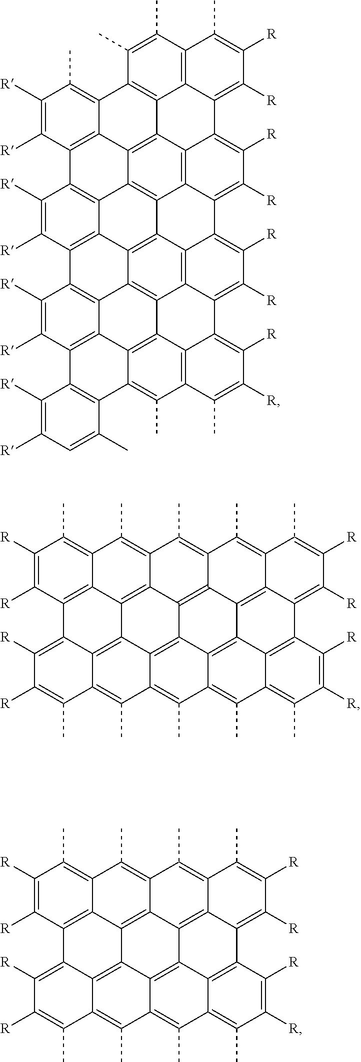 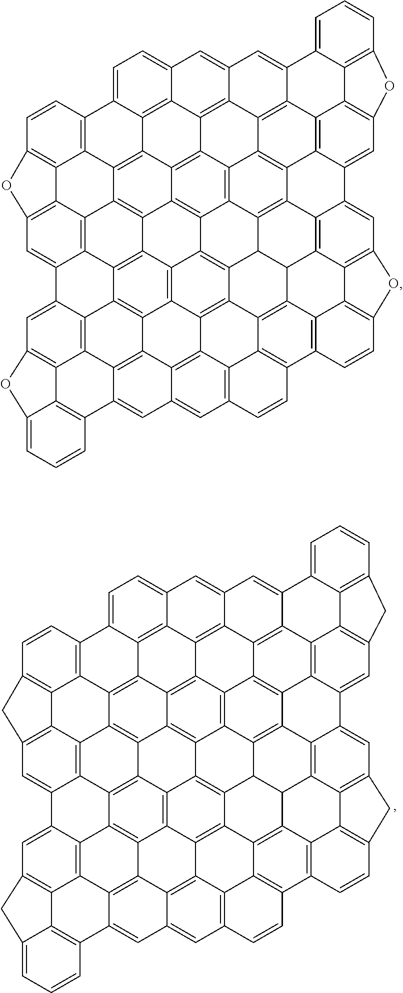 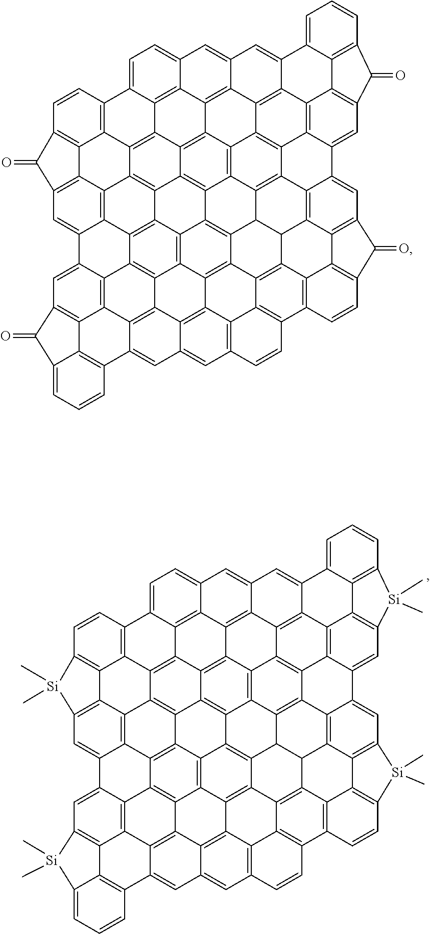 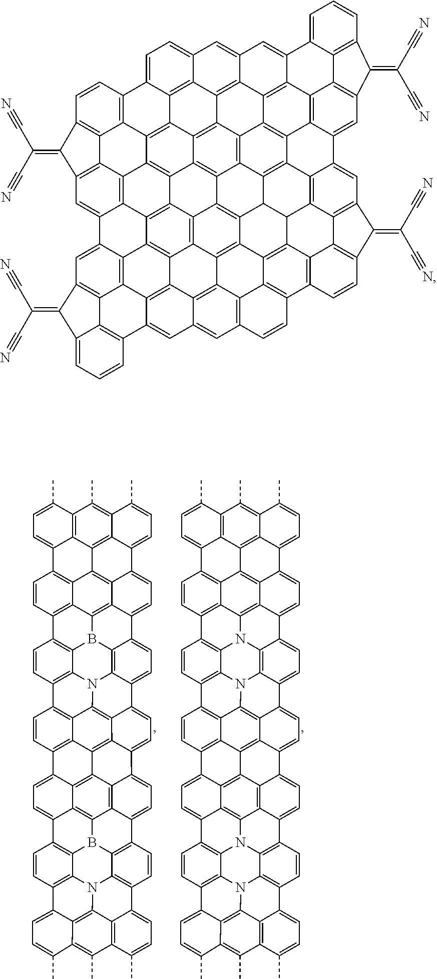 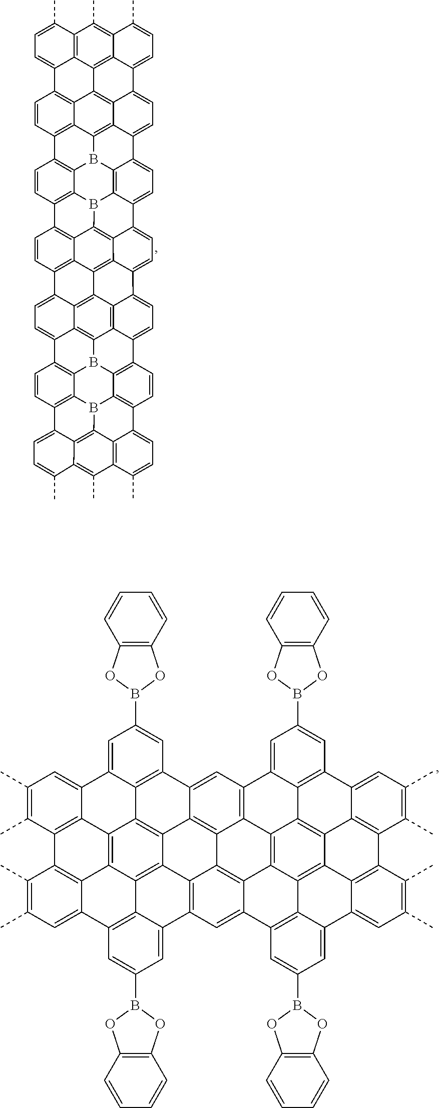 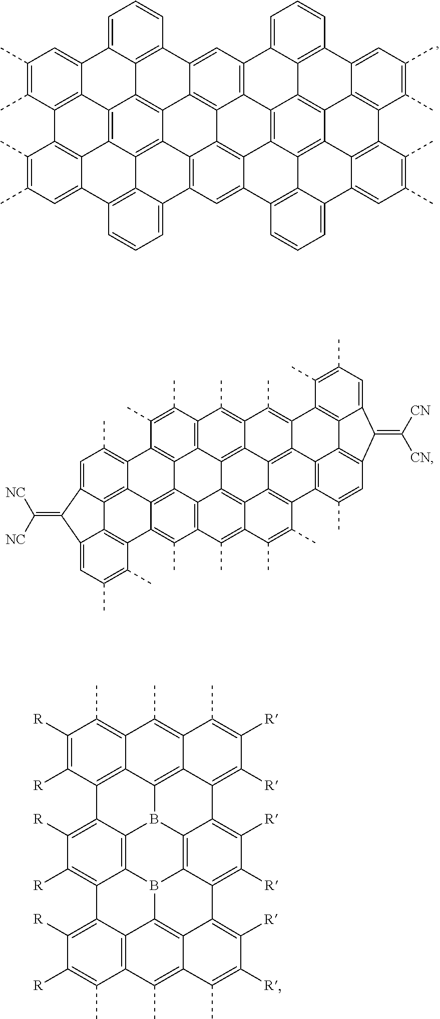 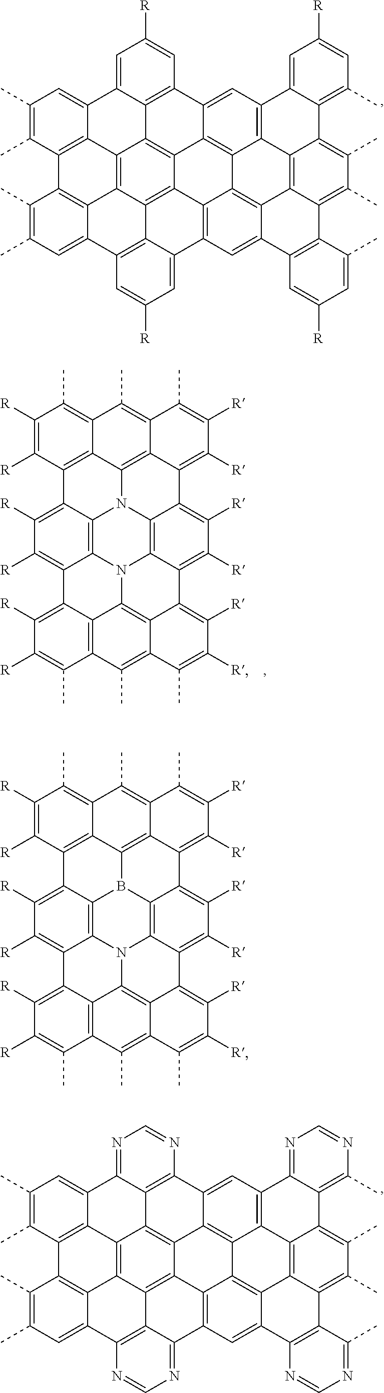 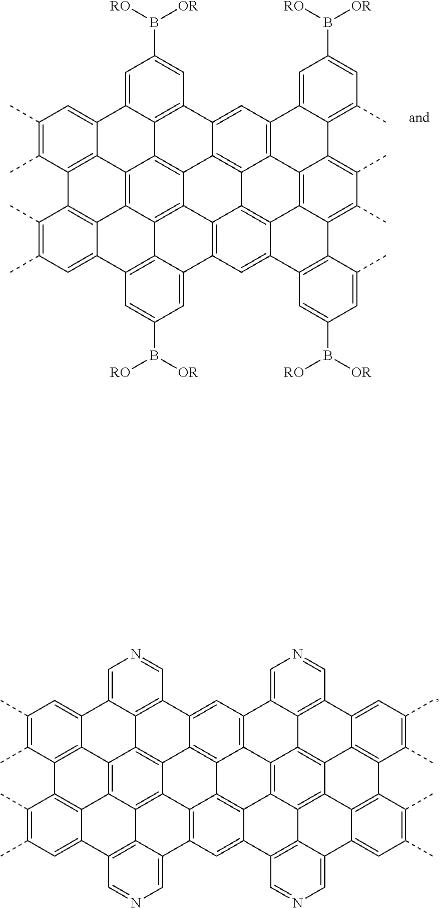
wherein
n can be 1 to 100,
R and R′ are independently selected from H, D, optionally substituted alkyl, optionally substituted heteroalkyl, optionally substituted alkenyl, optionally substituted heteroalkenyl, optionally substituted alkynyl, optionally substituted heteroalkynyl, optionally substituted cycloalkyl, optionally substituted cycloalkenyl, optionally substituted aryl, optionally substituted heterocycle, hydroxyl, halo, imine, amine (e.g., NH₂ and NR¹₂), amide, nitro, nitroso, nitrile, isocyanate, alkoxide (e.g., O-alkyl and O-ether), ester, aldehyde, ketone, carboxyl, thiol, SH, SR¹, thionyl, sulfonyl, SiR¹₃, PR¹₃, and heterocycle;
R¹ is selected from an optionally substituted alkyl, an optionally substituted heteroalkyl, an optionally substituted alkenyl, an optionally substituted heteroalkenyl, an optionally substituted alkynyl, or an optionally substituted heteroalkynyl, a cycloalkyl, an aryl, and a heterocycle; and
X is selected from O, S, N—R, P—R², and B—R² where R² is an optionally substituted alkyl, an optionally substituted heteroalkyl, an optionally substituted alkenyl, an optionally substituted heteroalkenyl, an optionally substituted alkynyl, or an optionally substituted heteroalkynyl, a cycloalkyl, an aryl, and a heterocycle.

8. The nanostructured composite of claim 7, wherein the structures have been oxidized to form graphene oxide structures.

9. The nanostructured composite of claim 8, wherein the structures have been oxidized and reduced to form reduced graphene oxide structures.

10. The nanostructured composite of claim 1, wherein the graphene derivatives are graphene oxide or reduced graphene oxide.

11. The nanostructured composite of claim 1, wherein the nanostructured composite is capable of reversibly adsorbing hydrogen gas.

12. The nanostructure composite of claim 11, wherein the hydrogen gas is reversibly adsorbed to the nanostructured composites by interacting with the plurality metal nanocrystals.

13. The nanostructured composite of claim 1, wherein the nanostructured composites are able to store and deliver hydrogen gas at a gravimetric capacity which exceeds 5.5 wt % of the nanostructured composite.

14. The nanostructured composite of claim 13, wherein the nanostructured composites are able to store and deliver hydrogen gas at a gravimetric capacity which exceeds 6.0 wt % of the nanostructured composite.

15. The nanostructured composite of claim 14, wherein the nanostructured composites are able to store and deliver hydrogen gas at a gravimetric capacity which is about 6.38 wt % of the nanostructured composite.

16. The nanostructured composite of claim 1, wherein the nanostructured composites further comprise adsorbed hydrogen gas.

17. A gas storage or separation device comprising the nanostructured composites of claim 1.

18. The gas storage device of claim 17, wherein the device is used with a fuel cell and/or an internal combustion engine.

19. The gas storage device of claim 18, wherein the device is configured to be used in a vehicle.

20. (canceled)

21. The gas separation device of claim 17, wherein the gas separation device is a membrane-based separation device.

22. A method to separate and/or store hydrogen gas, comprising contacting a nanostructured composite of claim 1 with hydrogen gas or a gas mixture comprising hydrogen gas.

23. The method of claim 22, wherein the method is performed at a temperature from 100° C. to 300° C.

24. The method of claim 22, wherein the method is performed at between 5 to 200 bar.

25. The method of claim 24, wherein the method is performed at about 15 bar.

26. The method of claim 22, wherein the adsorbed hydrogen gas can be released from the nanostructured composite by heating the nanostructured composite at a temperature from 25° C. to 350° C. and/or reducing the pressure to 0 bar.

27. The method of any one of claims 22, wherein the gas mixture comprising hydrogen gas is selected from water gas, partial decomposition of gaseous hydrocarbons, natural gas, and waste gas from destructive hydrogenation processes.

28. A method to fabricate the nanostructured composites of claim 1, comprising:
adding a mixture comprising ball-milled graphene oxide, bis(cyclopentadienyl)magnesium, and a first solvent to a solution comprising a reducing agent and a second solvent,
wherein the first and second solvent may or may not be the same solvent.

29. The method of claim 28, wherein the reducing agent is selected from lithium naphthalenide, hydrazine, thiourea dioxide, NaHSO₃, sodium borohydride, and thiophene.

30. The method of claim 29, wherein the reducing agent is lithium naphthalenide.

31. The method of claim 28 any one of claims 28 to 30, wherein the first and second solvent is tetrahydrofuran.

32. A catalytic, CO₂ reduction or water splitting method comprising the nanostructured composite of claim 1.

33. The nanostructured composite of claim 1, wherein the graphene derivative comprises a graphene nanoribbon.
